(19) United States
(12) Patent Application Publication
(10) Pub. No.: US 2025/0077066 A1
(43) Pub. Date: Mar. 6, 2025

(54) SYSTEMS AND METHODS FOR SCROLLING A USER INTERFACE ELEMENT

(71) Applicant: Apple Inc., Cupertino, CA (US)

(72) Inventor: Gregory LUTTER, Boulder Creek, CA (US)

(21) Appl. No.: 18/818,402

(22) Filed: Aug. 28, 2024

Related U.S. Application Data
(60) Provisional application No. 63/579,223, filed on Aug. 28, 2023.

(51) Int. Cl. G06F 3/0485; G06F 3/01; G06F 3/0482

(52) U.S. Cl. CPC G06F 3/0485; G06F 3/012; G06F 3/013; G06F 3/0482

(57) ABSTRACT

Some examples of the disclosure are directed to systems and methods for scrolling a user interface element. A user interface element including a plurality of selectable options scrollable along a first axis can be presented in an environment by a device. In some examples, the device detects an input corresponding to a request to scroll the user interface element. In accordance with a determination that the input satisfies one or more first criteria, including a criterion that is satisfied when the input includes movement of the device that corresponds to movement of a head of a user that exceeds a threshold amount of movement over a period of time, the device scrolls the user interface element in a first mode of operation. In accordance with a determination that the input satisfies one or more second criteria, the device scrolls the user interface element in a second mode of operation.

### CROSS-REFERENCE TO RELATED APPLICATIONS

This application claims the benefit of U.S. Provisional Application No. 63/579,223, filed Aug. 28, 2023, the entire disclosure of which is herein incorporated by reference for all purposes.

### FIELD OF THE DISCLOSURE

This relates generally to systems and methods for scrolling a user interface element in an environment.

### BACKGROUND OF THE DISCLOSURE

Some computer graphical environments provide two-dimensional and/or three-dimensional environments where at least some objects displayed for a user's viewing are virtual and generated by a computer. For example, a plurality of content items are often presented in computer graphical environments as a scrollable list. Providing efficient methods for scrolling a scrollable list in a computer graphical environment can improve user experience.

### SUMMARY OF THE DISCLOSURE

Some examples of the disclosure are directed to systems and methods for scrolling a user interface element in a first mode of operation or a second mode of operation. In some examples, the user interface element is presented in an environment by an electronic device. In some examples, the electronic device is in communication with a display and one or more input devices. In some examples, the electronic device presents, via the display, a user interface element including a plurality of selectable options scrollable along a first axis in an environment. In some examples, the electronic device detects, via the one or more input devices, a first input corresponding to a request to scroll the user interface element along the first axis. In some examples, in accordance with a determination that the first input satisfies one or more first criteria, the one or more first criteria including a criterion that is satisfied when the first input includes movement of the electronic device that corresponds to movement of a head of a user of the electronic device that exceeds a threshold amount of movement over a period of time, the electronic device scrolls the user interface element in a first mode of operation. In some examples, in accordance with a determination that the first input satisfies one or more second criteria, the electronic device scrolls the user interface element in a second mode of operation that is different from the first mode of operation.

In some examples, scrolling the user interface element in the first mode of operation corresponds to scrolling the user interface element based on movement of the electronic device. In some examples, the movement of the electronic device includes rotation of the electronic device relative to the first rotation axis that corresponds to rotation of the head of the user of the electronic device relative to the first rotation axis in the environment. For example, the first rotation axis corresponds to a pitch axis, the rotation of the electronic device includes rotation of the head about the pitch axis, and the threshold amount of movement corresponds to a threshold amount of rotation about the pitch axis). In some examples, the threshold amount of movement corresponds to an average amount of movement of the electronic device corresponding to an average amount of movement of the head of the user over a period of time. In some examples, exceeding the threshold amount of movement over the period of time corresponds to maintaining an average amount of movement over the period of time. For example, the movement of the electronic device exceeds the threshold amount of movement when an average amount of movement of the electronic device per frame exceeds a threshold amount per frame over a set of frames (e.g., 1, 2, 3, 4, 5, 10, 15, 20, 25, 50, or 100 frames).

In some examples, while initiating scrolling of the user interface element in the first mode of operation, the electronic device presents an animation in the environment. In some examples, presenting the animation in the environment includes changing a spatial arrangement of the plurality of selectable options. In some examples, changing the spatial arrangement of the plurality of selectable options includes decreasing a distance between the plurality of selectable options and a location of a first selectable option of the plurality of selectable options. In some examples, the first selectable option of the plurality of selectable options corresponds to a selectable option with a current focus in the user interface element.

In some examples, scrolling the user interface element in the second mode of operation corresponds to scrolling the user interface element based on attention of the user of the electronic device directed to the user interface element. In some examples, attention of the user of the electronic device corresponds to gaze of the user of the electronic device directed to the user interface element. In some examples, the one or more second criteria include a criterion that is satisfied when the first input includes a change in a location of gaze of the user of the electronic device from being directed to a first selectable option of the plurality of selectable options to a second selectable option, different from the first selectable option, of the plurality of selectable options. In some examples, the one or more second criteria include a criterion that is satisfied when the first input includes movement of the electronic device that corresponds to movement of the head of the user of the electronic device that is within the threshold amount of movement.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-3D illustrate an electronic device presenting a user interface element that is scrollable in an environment according to some examples of the disclosure.

FIGS. 4A-4K illustrate an electronic device presenting a user interface element in an environment that is scrollable in different modes of operation according to some examples of the disclosure.

FIGS. 5A-5B illustrate an electronic device presenting a user interface element in an environment that is scrollable along a second axis opposite from the first axis in an environment according to some examples of the disclosure.

FIG. 6 illustrates an example process for scrolling a user interface element in a first mode of operation or a second mode of operation based on detection of movement of an electronic device according to some examples of the disclosure.

FIG. 7 illustrates an example process for scrolling a user interface element in a first mode of operation and ceasing to scroll the user interface element in the first mode of operation according to some examples of the disclosure.

### DETAILED DESCRIPTION

Some examples of the disclosure are directed to systems and methods for scrolling a user interface element in a first mode of operation or a second mode of operation. In some examples, the user interface element is presented in an environment by an electronic device. In some examples, the electronic device is in communication with a display and one or more input devices. In some examples, the electronic device presents, via the display, a user interface element including a plurality of selectable options scrollable along a first axis in an environment. In some examples, the electronic device detects, via the one or more input devices, a first input corresponding to a request to scroll the user interface element along the first axis. In some examples, in accordance with a determination that the first input satisfies one or more first criteria, the one or more first criteria including a criterion that is satisfied when the first input includes movement of the electronic device that corresponds to movement of a head of a user of the electronic device that exceeds a threshold amount of movement over a period of time, the electronic device scrolls the user interface element in a first mode of operation. In some examples, in accordance with a determination that the first input satisfies one or more second criteria, the electronic device scrolls the user interface element in a second mode of operation that is different from the first mode of operation.

In some examples, scrolling the user interface element in the first mode of operation corresponds to scrolling the user interface element based on movement of the electronic device. In some examples, the movement of the electronic device includes rotation of the electronic device relative to the first rotation axis that corresponds to rotation of the head of the user of the electronic device relative to the first rotation axis in the environment. For example, the first rotation axis corresponds to a pitch axis, the rotation of the electronic device includes rotation of the head about the pitch axis, and the threshold amount of movement corresponds to a threshold amount of rotation about the pitch axis). In some examples, the threshold amount of movement corresponds to an average amount of movement of the electronic device corresponding to an average amount of movement of the head of the user over a period of time. In some examples, exceeding the threshold amount of movement over the period of time corresponds to maintaining an average amount of movement over the period of time. For example, the movement of the electronic device exceeds the threshold amount of movement when an average amount of movement of the electronic device per frame exceeds a threshold amount per frame over a set of frames (e.g., 1, 2, 3, 4, 5, 10, 15, 20, 25, 50, or 100 frames).

In some examples, while initiating scrolling of the user interface element in the first mode of operation, the electronic device presents an animation in the environment. In some examples, presenting the animation in the environment includes changing a spatial arrangement of the plurality of selectable options. In some examples, changing the spatial arrangement of the plurality of selectable options includes decreasing a distance between the plurality of selectable options and a location of a first selectable option of the plurality of selectable options. In some examples, the first selectable option of the plurality of selectable options corresponds to a selectable option with a current focus in the user interface element.

In some examples, scrolling the user interface element in the second mode of operation corresponds to scrolling the user interface element based on attention of the user of the electronic device directed to the user interface element. In some examples, attention of the user of the electronic device corresponds to gaze of the user of the electronic device directed to the user interface element. In some examples, the one or more second criteria include a criterion that is satisfied when the first input includes a change in a location of gaze of the user of the electronic device from being directed to a first selectable option of the plurality of selectable options to a second selectable option, different from the first selectable option, of the plurality of selectable options. In some examples, the one or more second criteria include a criterion that is satisfied when the first input includes movement of the electronic device that corresponds to movement of the head of the user of the electronic device that is within the threshold amount of movement.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction, rotation about a pitch axis), the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise rotation about a roll axis), the tilt-locked object is not repositioned within the three-dimensional environment.

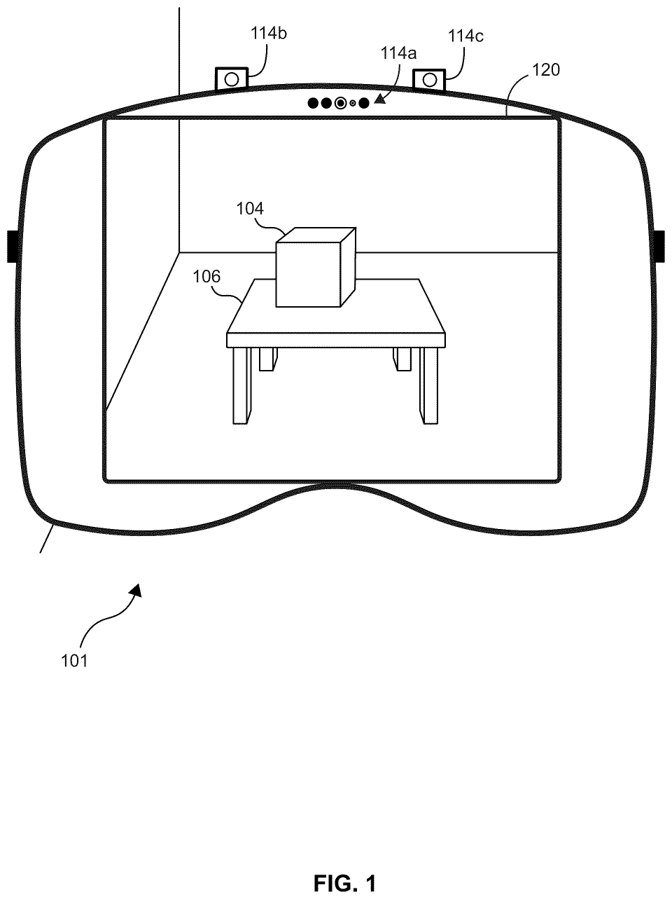

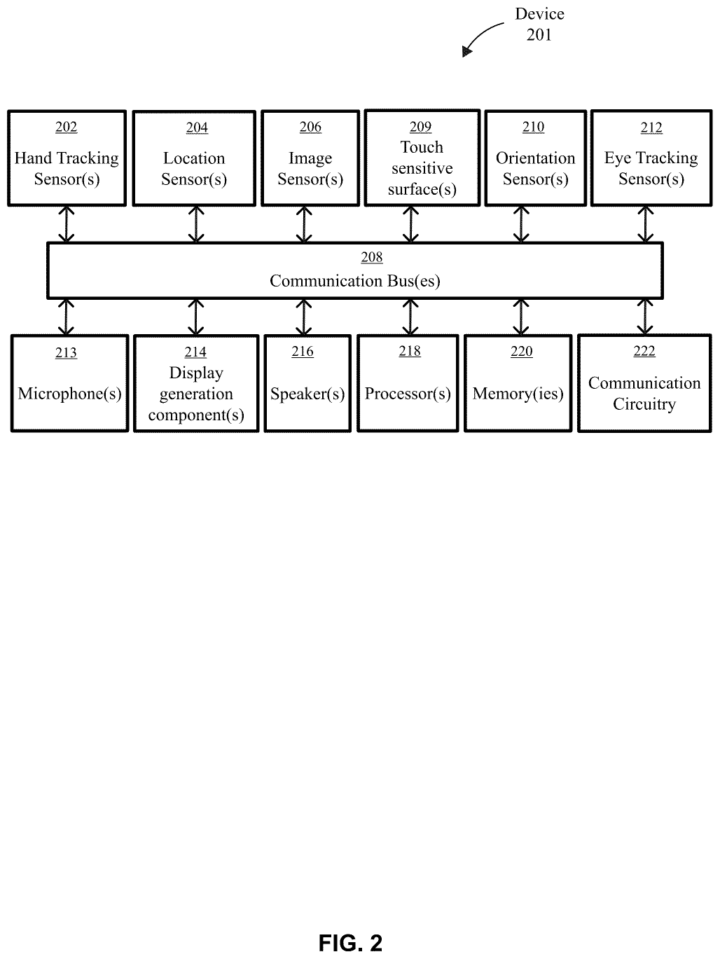

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

In some examples, the display 120 is provided as a passive component (e.g., rather than an active component) within electronic device 101. For example, the display 120 may be a transparent or translucent display, as mentioned above, and may not be configured to display virtual content (e.g., images of the physical environment captured by external image sensors 114b and 114c and/or virtual object 104). Alternatively, in some examples, the electronic device 101 does not include the display 120. In some such examples in which the display 120 is provided as a passive component or is not included in the electronic device 101, the electronic device 101 may still include sensors (e.g., internal image sensor 114a and/or external image sensors 114b and 114c) and/or other input devices, such as one or more of the components described below with reference to FIG. 2.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a device 201 according to some examples of the disclosure. In some examples, device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso, and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards interactions with one or more virtual objects that are displayed in a three-dimensional environment presented at an electronic device (e.g., corresponding to electronic device 201). In some examples, the electronic device presents a user interface element that is scrollable in multiple modes of operation in a three-dimensional environment in response to user input.

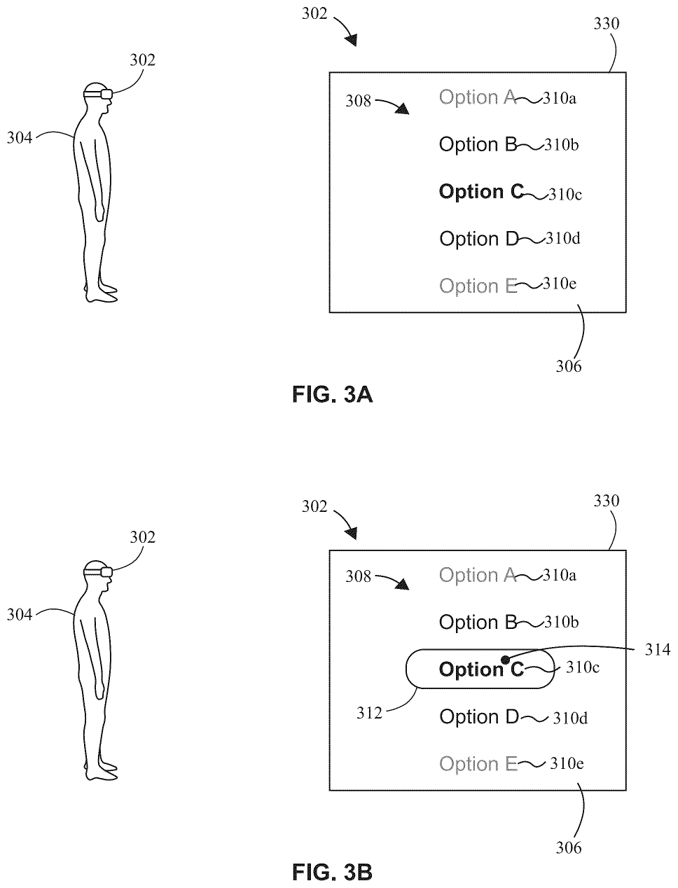

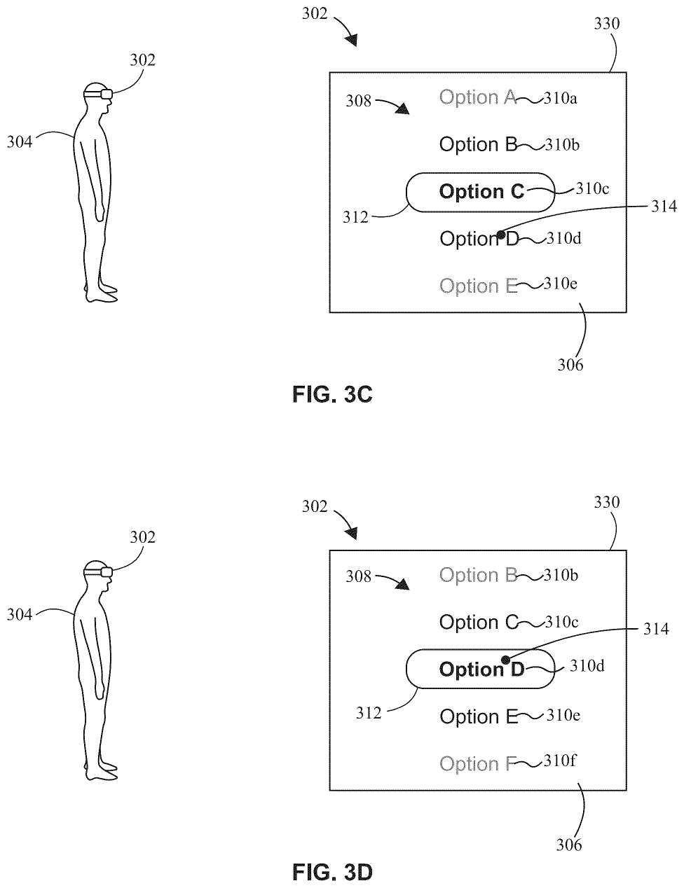

FIGS. 3A-3D illustrate an electronic device presenting a user interface element that is scrollable in an environment according to some examples of the disclosure. Particularly, FIGS. 3A-3D show a user 304 wearing an electronic device 302. In some examples, electronic device 302 has one or more characteristics of electronic device 101 and/or electronic device 201 as described above. In some examples, as shown in FIGS. 3A-3D, electronic device 302 is a head-mounted display that includes a display generation component 330 (e.g., or optionally one or more display generation components that have one or more characteristics of display generation component(s) 214 as described above) that presents an environment 306 to user 304. In some examples, electronic device 302 includes one or more image sensors (e.g., including one or more characteristics of image sensors 114a-114c and/or image sensor(s) 206 as described above) configured to detect a physical environment (e.g., having one or more characteristics of a real-world environment and/or physical environment described above) of user 304 and/or movements of one or more portions of user 304 (e.g., hands, head and/or eyes) and/or attention (e.g., gaze) of user 304.

In some examples, environment 306 is a three-dimensional environment that is presented to user 304 through display generation component 330 of electronic device 302. In some examples, environment 306 is an extended reality (XR) environment having one or more characteristics of an XR environment described above. For example, from a current viewpoint of user 304, one or more virtual elements (e.g., user interface element 308) and/or one or more physical objects (e.g., real-world table 106 as shown and described with reference to FIG. 1) from a physical environment of user 304 are visible (e.g., through video passthrough or optical see-through of the physical environment of user 304 that is visible to user 304 through display generation component 330). In some examples, environment 306 is a virtual reality environment (e.g., environment 306 is fully or partially immersive (e.g., user 304 controls a level of immersion through one or more input devices of electronic device 302)).

FIG. 3A illustrates electronic device 302 presenting a user interface element 308 in environment 306. As shown in FIG. 3A, user interface element 308 is a list that includes selectable options 310a-310e. In some examples, selectable options 310a-310e are a portion (e.g., subset) of a plurality of selectable options that are associated with user interface element 308 (e.g., one or more selectable options of the plurality of selectable options are not currently visible/displayed in environment 306 in FIG. 3A). In some examples, the plurality of selectable options associated with user interface element 308 (e.g., selectable options 310a-310e shown in FIG. 3A) includes selectable content items, including text, photos, and/or media (e.g., music) that are selectable by user 304 (e.g., through a user input). User interface element 308 is optionally associated with a respective application (e.g., a media streaming application), and the plurality of selectable options include selectable content associated with the respective application. In some examples, user interface element 308 is associated with a system user interface, and the plurality of selectable options are settings that are selectable and/or controllable by user 304 in a menu of the system user interface. In some examples, user interface element 308 is arranged in environment 306 in a world-locked orientation, body-locked orientation, a tilt-locked orientation, or head-locked orientation (e.g., including one or more characteristics of a world-locked orientation, body-locked orientation, tilt-locked orientation and/or head-locked orientation as described above).

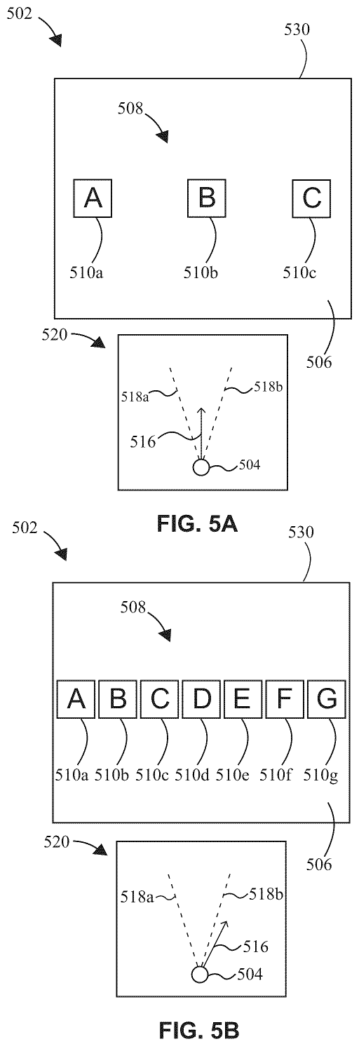

In some examples, due to spatial constraints, only a portion of a plurality of selectable options associated with user interface element 308 is presented to user 304 in environment 306 at a given time (e.g., selectable options 310a-310e are a portion of the plurality of selectable options that is associated with user interface element 308 as described above). In some examples, user interface element 308 is scrollable to present one or more selectable options of the plurality of selectable options that are currently hidden to user 304 (e.g., are not currently displayed) in environment 306. In some examples, user interface element 308 is scrollable along a first axis relative to environment 306 (e.g., selectable options 310a-310c (e.g., the portion of the selectable options of the plurality of selectable options associated with user interface element 308 that are visible in environment 306) are arranged along the first axis). For example, the first axis corresponds to an axis (e.g., an axis that is not necessarily displayed in the environment 306) that extends vertically in environment 306 from the current viewpoint of user 304. In some examples, user interface element 308 is scrollable along a second axis (e.g., corresponding to an axis extending horizontally from the current viewpoint of user 304) relative to environment 306 (e.g., as shown and described with reference to user interface element 508 in FIGS. 5A-5B). In some examples, user interface element 308 corresponds to a bounded list. For example, when scrolling user interface element 308 in a first direction, a selectable option of the plurality of selectable options associated with user interface element 308 corresponds to a first bound. In some examples, upon reaching the selectable option corresponding to the first bound while scrolling user interface element 308 in the first direction, user interface element 308 is no longer scrollable. For example, when scrolling user interface element 308 in a second direction (e.g., opposite from the first direction), a selectable option of the plurality of selectable options associated with user interface element 308 corresponds to a second bound of the bounded list. In some examples, upon reaching the selectable option corresponding to the second bound while scrolling user interface element 308 in the second direction, user interface element 308 is no longer scrollable. In some examples, user interface element 308 corresponds to an unbounded list. For example, scrolling user interface element 308 includes cycling through the plurality of selectable options associated with user interface element 308 without reaching a selectable option of the plurality of selectable options corresponding to a bound of the list (e.g., user interface element 308 is a carousel list). In some examples, scrolling user interface element 308 includes movement of the visible portion of the plurality of selectable options in one or more dimensions relative to environment 306. For example, scrolling user interface element 308 includes movement of selectable options 310a-310e in a vertical dimension relative to the current viewpoint of user 304 in environment 306. For example, scrolling user interface element 308 includes movement of selectable options 310a-310e in a vertical dimension and a dimension of depth relative to the current viewpoint of user 304 in environment 306 (e.g., user interface element 308 is a carousel list that is rotated in response to user input).

In some examples, scrolling user interface element 308 includes moving and/or replacing which selectable options of the plurality of selectable options are currently visible to user 304 in environment 306. In some examples, moving and/or replacing which selectable options of the plurality of selectable options are currently visible to user 304 includes presenting an animation in environment 306 that includes changing the visual prominence (e.g., opacity, brightness, color and/or size) of one or more selectable options as they are moved and/or replaced. Accordingly, different selectable options of the plurality of selectable options are presented with different amounts of visual prominence based on their relative position in user interface element 308. For example, as shown in FIG. 3A, selectable options 310a and 310c, which are presented at the top and bottom of user interface element 308, respectively, in environment 306, are presented with less visual prominence compared to selectable options 310b-310d (e.g., presenting selectable options 310a and 310e with less visual prominence informs user 304 that selectable options 310a and 310e do not have a current focus and that scrolling user interface element 308 will cause selectable option 310a or selectable option 310c to cease to be presented in user interface element 308). In some examples, selectable options 310a-310e appear to be presented with different amounts of visual prominence from the perspective of user 304 based on a distance of selectable options 310a-310e (e.g., relative to a dimension of depth) from the current viewpoint of user 304 in environment 306. For example, scrolling user interface element 308 includes movement of selectable options 310a-310e in a vertical direction and a direction of depth relative to the current viewpoint of user 304 in environment 306 (e.g., as a respective selectable option of the plurality of selectable options is moved (e.g., during scrolling of user interface element 308) from a center of user interface element 308 toward the top or bottom of user interface element 308, the respective selectable option is moved farther in depth relative to the current viewpoint of user 304 in environment 306). Accordingly, in some examples, selectable options 310a and 310e appear to have less visual prominence compared to selectable options 310b-310d from the perspective of user 304 because selectable options 310a and 310e are positioned in environment 306 at a greater distance from the current viewpoint of user 304 compared to selectable options 310b-310d.

As shown in FIG. 3A, selectable option 310c is presented at a center of user interface element 308 and includes the greatest amount visual prominence (e.g., selectable option 310c is displayed with a greater amount of opacity, brightness, color and/or size (e.g., with bolder font) compared to selectable options 310a-310b and 310d-310e) compared to the plurality of selectable options currently visible in environment 306. In some examples, presenting selectable option 310c with the greatest amount of visual prominence visually indicates to user 304 that selectable option 310c has a current focus (e.g., presenting selectable option 310c with a greater amount of visual prominence compared to different selectable options included in user interface element 308 informs user 304 that selectable option 310c is the option of the plurality of selectable options that would be selected in response to a selection input (e.g., an air pinch or tap gesture) provided by user 304). In some examples, in response to scrolling user interface element 308, selectable option 310c is replaced as the selectable option with the current focus of the plurality of selectable options associated with user interface element 308. It should be appreciated that although FIG. 3A (e.g., and FIGS. 3B-3D) illustrates five selectable options presented in environment 306, user interface element 308 may include various sizes relative to environment 306 that provides space for greater than or fewer than five selectable options to be presented in environment 306.

In some examples, user interface element 308 is scrollable in different modes of operation. For example, user interface element 308 is scrollable in response to detected attention directed to user interface element 308 by user 304. Attention of user 304 is optionally determined using a detected gaze of user 304 (e.g., through one or more eye tracking sensors having one or more characteristics of eye tracking sensor(s) 212 described with reference to FIG. 2). For example, user interface element 308 is scrollable in response to movement of electronic device 302 caused by (e.g., corresponding to) movement of a head of user 304 (e.g., because electronic device 302 is a head-mounted display worn by user 304). Scrolling user interface element 308 in the mode of operation that is based on movement of electronic device 302 is optionally independent of the detection of gaze of user 304 (e.g., electronic device 302 continues to track gaze of user 304, but does not use the detected gaze of user 304 to scroll user interface element 308 when scrolling user interface element 308 in the mode of operation that is based on movement of electronic device 302, or electronic device 302 ceases to track gaze of user 304 when scrolling user interface element 308 in the mode of operation that is based on movement of electronic device 302). In some examples, electronic device 302 provides a different scrolling functionality and presents different visual feedback in environment 306 while scrolling user interface element 308 based on detected attention of user 304 compared to while scrolling user interface element 308 based on movement of electronic device 302.

FIG. 3B illustrates selectable option 310c presented with an indication 312 in response to attention of user 304 being directed to selectable option 310c. As shown in FIG. 3B indication 312 is presented as a boundary displayed surrounding selectable option 310c. In some examples, in response to detecting attention of user 304 directed to selectable option 310c, electronic device 302 presents visual feedback different from indication 312 (e.g., an indication of a different size and/or shape than shown in FIG. 3B (e.g., a rectangle or an oval), or electronic device 302 changes a visual prominence (e.g., opacity, color, brightness and/or size) of selectable option 310c). In some examples, detecting attention of user 304 directed to selectable option 310c corresponds to detecting a gaze 314 (e.g., represented by a black circle in FIG. 3B) of user 304 directed to selectable option 310c. In some examples, indication 312 is presented in environment 306 in response to the detection of gaze 314 directed to selectable option 310c (e.g., indication 312 is optionally presented after gaze is directed to selectable option 310c for a threshold period of time (e.g., 0.1, 0.2, 0.5, 1, 2, 5 or 10 seconds)).

FIG. 3C illustrates user 304 providing an input corresponding to a change in the attention of user 304 from being directed to selectable option 310c to being directed to selectable option 310d. Particularly, as shown in FIG. 3C, gaze 314 is directed to selectable option 310d. In some examples, in response to a change in attention of user 304 from a selectable option that has current focus to a different selectable option of the plurality of selectable options, electronic device 302 scrolls user interface element 308 such that the different selectable option has the current focus (e.g., the different selectable option is presented as the center selectable option in user interface element 308 and is presented with indication 312).

FIG. 3D illustrates user interface element 308 scrolled in response to the input provided by user 304 in FIG. 3C. Particularly, as shown in FIG. 3D, selectable option 310d is presented as the selectable option of the plurality of selectable options that has the current focus in user interface element 308. In some examples, as a result of the scrolling of user interface element 308 (e.g., and/or in response to gaze 314 being directed to selectable option 310d), indication 312 is presented with selectable option 310d in environment 306. As shown in FIG. 3D, scrolling user interface element 308 includes moving selectable options 310b-310e vertically and replacing selectable option 310a with selectable option 310f in environment 306. For example, in response to the input (e.g., change in attention directed to user interface element 308) provided by user 304 in FIG. 3C, electronic device 302 ceases to present selectable option 310a (e.g., by gradually reducing the visual prominence of selectable option 310a while concurrently moving selectable option 310a until selectable option 310a ceases to be presented in environment 306). In some examples, scrolling user interface element 308 in response to the input provided by user 304 in FIG. 3C includes presenting an animation that includes gradually ceasing to present (e.g., by gradually reducing the opacity, brightness, size and/or color of) selectable option 310a while gradually presenting (e.g., by gradually increasing the opacity, brightness, size and/or color of) selectable option 310d in environment 306 (e.g., while concurrently moving selectable option 310a and selectable option 310f in accordance with the scroll of user interface element 308). In some examples, scrolling user interface element 308 includes movement of the plurality of selectable options visible to user 304 in a vertical direction and optionally in a direction of depth relative to the current viewpoint of user 304 (e.g., selectable option 310d is moved to a position in environment 306 at a reduced distance from the current viewpoint of user 304 and/or selectable option 310b is moved to a position in environment at a greater distance from the current viewpoint of user 304 in response to the input provided by user 304 in FIG. 3C).

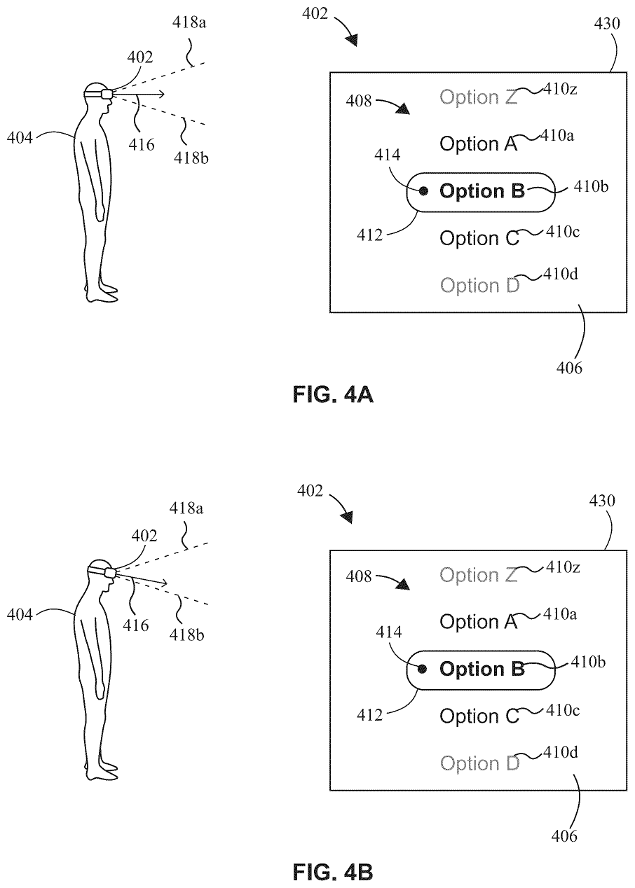

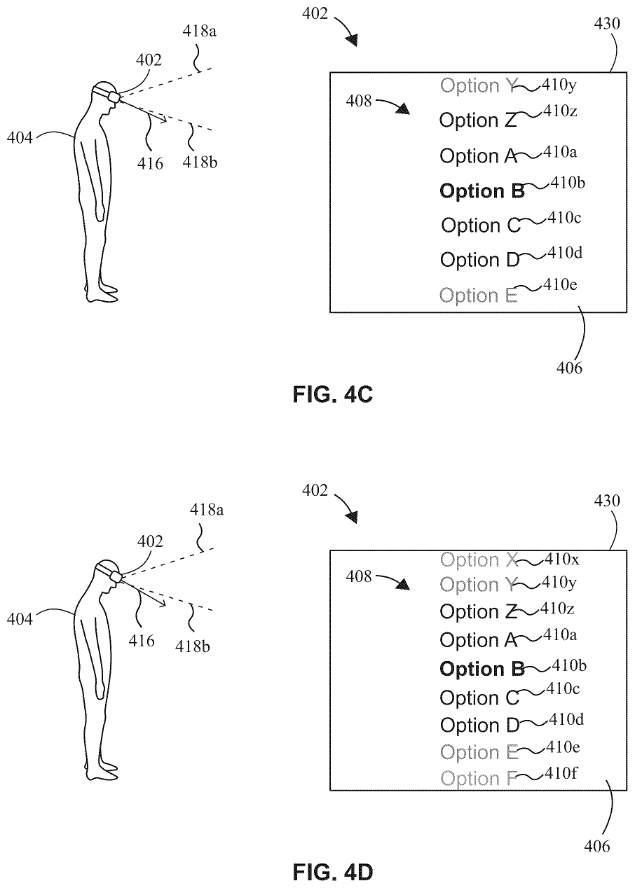

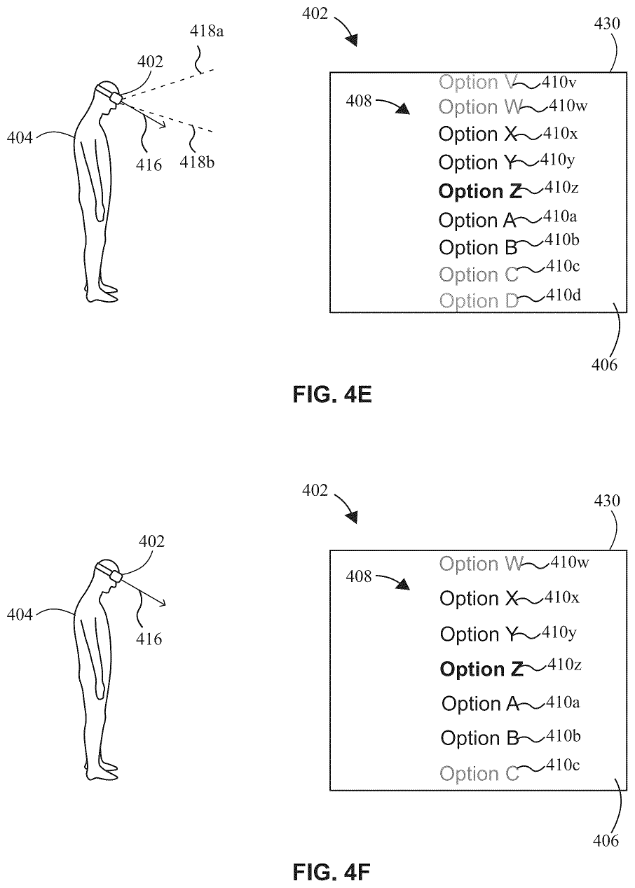

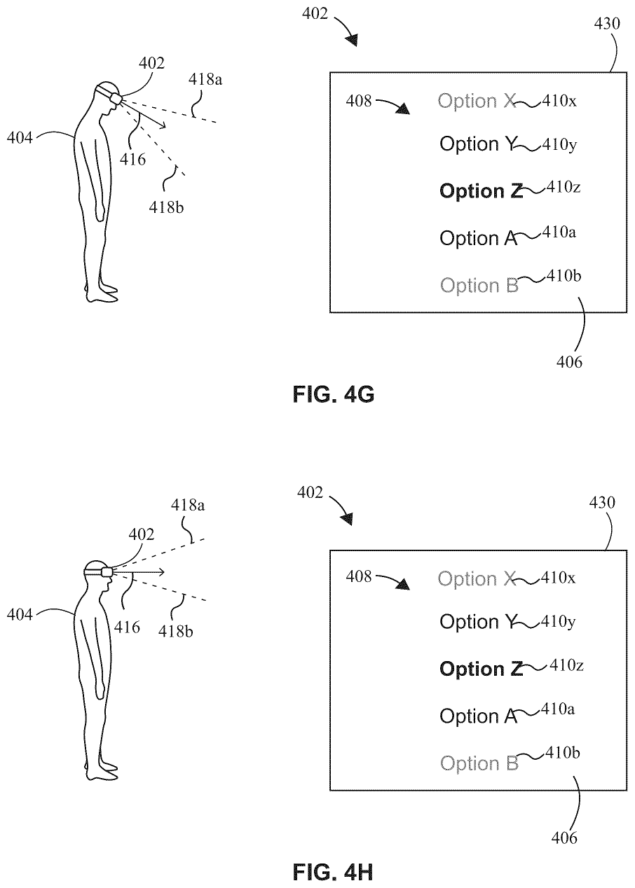

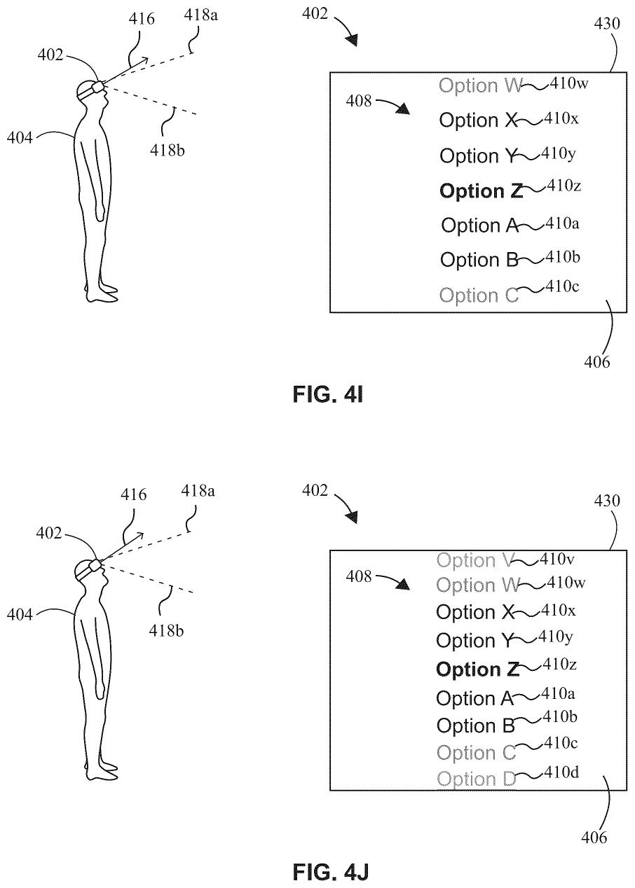

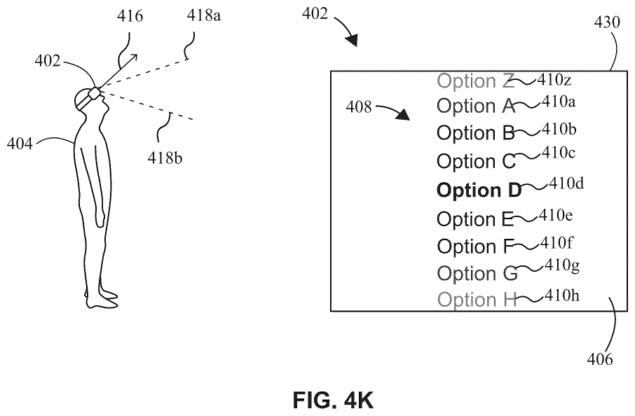

FIGS. 4A-4K illustrate an electronic device presenting a user interface element in an environment that is scrollable in different modes of operation according to some examples of the disclosure. In some examples, electronic device 402 has one or more characteristics of electronic device 302 shown and described with reference to FIGS. 3A-3D. As shown in FIGS. 4A-4K, electronic device 402 includes a display generation component 430 (e.g., display generation component 430 has one or more characteristics of display generation component 330 described with reference to FIGS. 3A-3D). In some examples, environment 406 has one or more characteristics of environment 306 shown and described with reference to FIGS. 3A-3D. In some examples, user interface element 408 has one or more characteristics of user interface element 308 shown and described with reference to FIGS. 3A-3D.

FIG. 4A illustrates user interface element 408 presenting selectable options 410z-410d in environment 406. In some examples, selectable options 410z-410d are a portion (e.g., subset) of a plurality of selectable options associated with user interface element 408 (e.g., selectable options 410z-410d have one or more characteristics of selectable options 310a-310e shown and described with reference to FIGS. 3A-3D). In some examples, user interface element 408 is scrollable based on detection of attention of user 404 directed to user interface element 408. As shown in FIG. 4A, attention of user 404 (e.g., gaze 414) is directed to selectable option 410b. In response to detecting attention of user 404 directed to selectable option 410b, electronic device 402 presents selectable option 410b with indication 412 (e.g., indication 412 has one or more characteristics of indication 312 shown and described with reference to FIGS. 3B-3D). In some examples, as previously discussed above, in response to user 404 directing gaze 414 to a selectable option different from selectable option 410b, electronic device 402 scrolls user interface element 408 such that the selectable option different from selectable option 410b is presented as the selectable option with indication 412 (e.g., corresponding to the selectable option with the current focus).

In some examples, movement of electronic device 402 that exceeds a threshold amount of movement causes electronic device 402 to change the mode of operation of scrolling user interface element 408. Particularly, user interface element 408 is configured to be scrolled in a mode of operation that is based on movement of electronic device 402 that exceeds a threshold amount of movement (e.g., relative to a first rotation axis, such as rotation about a pitch axis of electronic device 402 (e.g., corresponding to a change in vertical tilt of electronic device 402 relative to environment 406)). In FIG. 4A, threshold lines 418a-418b are shown relative to electronic device 402 worn by user 404. In some examples, threshold lines 418a-418b are a schematic representation of the threshold amount of movement of electronic device 402 (e.g., rotation about a pitch axis of electronic device 402) that is required to scroll user interface element 408 in the mode of operation that is based on movement of electronic device 402. Additionally, a current orientation of electronic device 402 (e.g., represented by orientation arrow 416) is shown between threshold lines 418a-418b.

In some examples, the threshold amount of movement is established relative to an initial position (e.g., pose, including orientation) of electronic device 402 relative to environment 406 (e.g., relative to the first rotation axis, such as a pitch axis of electronic device 402). In some examples, movement of electronic device 402 relative to environment 406 corresponds to rotation of electronic device caused by (e.g., corresponding to) rotation of the head of user 404 relative to environment 406 (e.g., relative to the first rotation axis, such as the pitch axis of electronic device 402). For example, the threshold amount of movement of electronic device 402 corresponds to a threshold change in orientation (e.g., 0.1, 0.5, 1, 2, 3, 4, 5, 10, 15, 20, 25, 30, 35, 40, 45 or 50 degrees) from the initial position electronic device 402 had prior to the movement of electronic device 402 being detected (e.g., the initial position of electronic device 402 is represented by orientation arrow 416 in FIG. 4A). In some examples, the threshold amount of movement corresponds to an average amount movement of electronic device 402 over a period of time (e.g., 0.1, 0.2, 0.5, 1, 2, 5 or 10 seconds). For example, the threshold amount of movement corresponds to an average amount of change in orientation of 0.1, 0.5, 1, 2, 3, 4, 5, 10, 15, 20, 25, 30, 35, 40, 45 or 50 degrees from the initial position of electronic device 402 relative to environment 406 over a threshold amount of time (e.g., 0.1, 0.2, 0.5, 1, 2, 5 or 10 seconds).

In some examples, the threshold amount of movement over the threshold amount of time includes a speed and/or velocity (e.g., angular velocity) of the movement of electronic device 402 (e.g., relative the first rotation axis, such as the pitch axis of electronic device 402). For example, the threshold amount of movement is exceeded when a velocity of the movement (e.g., rotation) of electronic device 402 exceeds a threshold amount (e.g., 0.01, 0.02, 0.05, 0.1, 0.2, 0.5, or 1 m/s) over a threshold amount of time (e.g., 0.1, 0.2, 0.5, 1, 2, 5, or 10 seconds) (e.g., in accordance with a determination that the movement of electronic device 402 exceeds the threshold velocity for less than the threshold amount of time, electronic device 402 forgoes scrolling user interface element 408 in the mode of operation that is based on detected movement of electronic device 402).

In some examples, exceeding the threshold amount of movement over the threshold amount of time includes maintaining above a threshold average amount of movement of electronic device 402 over a threshold amount of time (e.g., 0.1, 0.2, 0.5, 1, 2, 5, or 10 seconds). For example, the movement of electronic device 402 exceeds the threshold amount when electronic device 402 maintains above an average amount of movement (e.g., corresponding to distance, magnitude, speed, and/or velocity) per a sub-period of time (e.g., per 0.05, 0.1, 0.2, 0.5, 1, 2, or 5 seconds) over an extended period of time (e.g., 0.1, 0.5, 1, 2, 5, or 10 seconds) (e.g., the sub-period of time is 1 second, the extended period of time is 10 seconds, and in accordance with a determination that the average movement of electronic device 402 is above the threshold amount per second for less than 10 sequential seconds, electronic device 402 forgoes scrolling user interface element 408 in the mode of operation that is based on detected movement of electronic device 402). For example, the movement of electronic device 402 exceeds the threshold amount (e.g., including a distance, magnitude, speed, and/or velocity) when electronic device 402 maintains above an average amount of movement (e.g., above an average amount of distance, magnitude, and/or velocity) per frame (e.g., corresponding to one or more images captured by electronic device 402) over a set of frames (e.g., 1, 2, 3, 4, 5, 10, 15, 20, 25, 50, or 100 frames) (e.g., the set of frames is 5 frames, and in accordance with a determination that the average movement of electronic device 402 exceeds the threshold amount per frame in less than 5 sequential frames, electronic device 402 forgoes scrolling user interface element 408 in the mode of operation that is based on detected movement of electronic device 402). For example, the threshold amount of movement of electronic device 402 per frame corresponds to an amount of movement from the initial position of electronic device 402 described above (e.g., prior to detecting rotation of electronic device 402). Additionally, or alternatively, for example, the threshold amount of movement of electronic device 402 per frame corresponds to an amount of movement from a position electronic device 402 had in the previous frame.

In some examples, in accordance with rotation of the head of user 404 causing a change in orientation (e.g., rotation about the pitch axis) of electronic device 402 that exceeds the threshold amount of movement, electronic device 402 scrolls user interface element 408 in the mode of operation that is based on detected movement of electronic device 402. In some examples, in accordance with electronic device 402 detecting that movement of electronic device 402 does not exceed the threshold amount of movement relative to environment 406, electronic device 402 maintains scrolling user interface element 408 in the mode of operation that is based on attention (e.g., gaze) of user 404 directed to user interface element 408 (e.g., such as shown and described with reference to FIGS. 3A-3D).

FIG. 4B illustrates user 404 providing an input corresponding to movement of electronic device 402 by an amount that does not exceed the threshold amount of movement (e.g., that does not exceed threshold line 418a or 418b). In some examples, movement of electronic device 402 (e.g., as represented by the difference in orientation of orientation arrow 416 in FIG. 4B from FIG. 4A) corresponds to rotation of electronic device 402 that does not exceed the threshold amount of movement (e.g., corresponding to an average amount of movement (e.g., distance, magnitude, speed, and/or velocity) of electronic device 402 over a period of time). Accordingly, as shown in FIG. 4B, electronic device 402 maintains scrolling of user interface element 408 in the mode of operation that is based on attention of user 404 directed to user interface element 408.

In FIG. 4B, gaze 414 continues to be maintained at selectable option 410b. In accordance with gaze 414 continuing to be directed to selectable option 410b (e.g., and in accordance with the movement of electronic device 402 not exceeding the threshold amount of movement), electronic device 402 maintains the presentation of selectable option 410b with indication 412. In some examples, in accordance with movement of the head of user 404 not exceeding the threshold amount of movement, electronic device 402 continues to permit user interface element 408 to be scrolled in the mode of operation that is based on detected attention (e.g., gaze 414) of user 404.

FIG. 4C illustrates user 404 providing an input corresponding to movement of electronic device 402 that exceeds the threshold amount of movement. As shown in FIG. 4C, orientation arrow 416 (e.g., corresponding to the orientation of electronic device 402) exceeds threshold line 418b. In some examples, the input provided by user 404 in FIG. 4C is a continuation of the input provided by user 404 in FIG. 4B (e.g., user 404 provides continued head movement that causes electronic device 402 to move from the orientation shown in FIG. 4A to the orientation shown in FIG. 4C (e.g., optionally within a threshold period of time)). In some examples, as a result of the movement of electronic device 402 that exceeds the threshold amount of movement, electronic device 402 initiates scrolling of user interface element 408 in the mode of operation that is based on movement (e.g., rotation) of electronic device 402. In some examples, initiating scrolling of user interface element 408 in the mode of operation that is based on movement of electronic device 402 includes ceasing to scroll user interface element 408 based on detected attention of user 404 (e.g., scrolling user interface element 408 in the mode of operation that is based on movement of electronic device 402 includes scrolling user interface element 408 independent of a location of gaze 414 relative to user interface element 408). For example, electronic device 402 continues to track attention of user 404 and does not use the detected attention (e.g., gaze) to scroll user interface element 408. Alternatively, for example, electronic device 402 ceases to track attention of user 404 in response to detecting movement of electronic device 402 that exceeds the threshold amount of movement.

In some examples, electronic device 402 presents visual feedback in environment 406 while initiating scrolling of user interface element 408 in the mode of operation that is based on movement of electronic device 402. In some examples, presenting the visual feedback in environment 406 includes presenting an animation in environment 406 that includes changing a spatial arrangement of the plurality of selectable options associated with user interface element 408. Particularly, as shown in FIG. 4C, electronic device 402 decreases a distance presented between the plurality of selectable options included in user interface element 408. Accordingly, an increased number of selectable options of the plurality of selectable options is presented in environment 406 while scrolling in the mode of operation that is based on detected movement of electronic device 402 (e.g., compared to as shown in FIGS. 4A-4B). In some examples, FIG. 4C corresponds to an intermediate view of user interface element 408 during the presentation of the animation (e.g., FIG. 4C illustrates an intermediate position of the plurality of selectable options prior to the end of the animation). For example, prior to ceasing the presentation of the animation, electronic device 402 presents additional selectable options than selectable options 410y-410e presented in FIG. 4C. In some examples, changing the spatial arrangement of the plurality of selectable options during the animation includes presenting movement of the plurality of selectable options in one or more dimensions (e.g., in a vertical dimension or in the vertical dimension and in a dimension of depth in environment 406). In some examples, changing the spatial arrangement of the plurality of selectable options during the animation includes changing a visual prominence of the plurality of selectable options (e.g., opacity, brightness, color and/or size) based on the position of the plurality of selectable options in user interface element 408 during the movement of the plurality of selectable options. In some examples, presenting the animation includes maintaining the position of the selectable option of the plurality of selectable options that has the current focus in user interface element 408 (e.g., presenting the animation includes decreasing a distance between the plurality of selectable options and a location in the environment corresponding to the selectable option with the current focus). As shown in FIG. 4C, selectable option 410b, which has the current focus, maintains its position in user interface element 408 (e.g., relative to the position of selectable option 410b in FIGS. 4A-4B) while others of the plurality of selectable options that are presented in environment 406 different from selectable option 410b are moved. For example, presenting the animation includes moving a portion of the plurality of selectable options located above selectable option 410b in user interface element 408 (e.g., selectable options 410y-410a) toward the location of selectable option 410b from a first direction while concurrently moving a portion of the plurality of selectable options located below selectable option 410b in user interface element 408 (e.g., selectable options 410c-410e) toward the location of selectable option 410b from a second direction opposite from the first direction.

FIG. 4D illustrates electronic device 402 ceasing to display the animation initiated in FIG. 4C in response to the movement of electronic device 402 that exceeds the threshold amount of movement. As shown in FIG. 4D, the spatial arrangement of the plurality of selectable options is changed compared to that shown in FIG. 4C. Particularly, a distance between others of the plurality of selectable options in FIG. 4D and a location in environment 406 corresponding to the location of selectable option 410b is less than the distance between others of the plurality of selectable options and the location in environment 406 corresponding to the location of selectable option 410b shown in FIG. 4C. As a result of the decrease in distance between the plurality of selectable options in user interface element 408, additional selectable options of the plurality of selectable options are able to be presented in environment 406. As shown in FIG. 4D, selectable options 410x and 410f are presented in environment 406 as a result of the animation. Decreasing a distance between the plurality of selectable options of user interface element 408 in a mode of operation that is based on movement of electronic device 402 (e.g., caused by rotation of the head of user 404) provides user 404 a mode of operation for scrolling user interface element 408 more quickly and/or efficiently compared to scrolling user interface element 408 based on detecting attention (e.g., gaze) directed to user interface element 408 (e.g., which optionally requires more space to be presented between the selectable options visible in environment 406 in order to properly distinguish which respective selectable option attention is being directed to). In some examples, presenting selectable options 410x and 410f in environment 406 includes continuing the movement of the plurality of selectable options (e.g., in one or more dimensions in environment 406) as described with reference to FIG. 4C. As shown in FIG. 4D, selectable option 410b continues to maintain the same position in environment 406 while electronic device 402 presents the animation (e.g., movement of selectable options 410x-410a includes movement toward selectable option 410b from a first direction, and movement of selectable options 410c-410f includes movement toward selectable option 410b from a second direction opposite from the first direction). It should be appreciated that although FIG. 4D illustrates nine selectable options presented in environment 406, user interface element 408 may include various sizes relative to environment 406 while scrolling in the mode of operation based on movement of electronic device 402 that provides space for more or less than nine selectable options to be presented in environment 406.

In some examples, electronic device 402 initiates scrolling of user interface element 408 based on the movement of electronic device 402 that exceeds the threshold amount of movement. In some examples, electronic device 402 scrolls user interface element 408 while presenting the animation (e.g., electronic device 402 begins to scroll user interface element 408 in accordance with the movement of electronic device 402 while changing the spatial arrangement of the plurality of selectable options in environment 406). In some examples, electronic device 402 initiates scrolling of user interface element 408 after the animation ceases to be presented in environment 406 (e.g., after the change in spatial arrangement of the plurality of selectable options is completed, as shown in FIG. 4D). In some examples, while presenting the animation in environment 406, electronic device 402 continues to track movement of electronic device 402 (e.g., electronic device 402 continues to detect movement of electronic device 402 corresponding to head movement of user 404 after the movement of electronic device 402 exceeds the threshold amount of movement). As shown in FIG. 4D, the orientation of electronic device 402 represented by orientation arrow 416 exceeds the threshold amount of movement (e.g., threshold line 418b) by a greater amount compared to that shown in FIG. 4C (e.g., user 404 continues to move their head once exceeding the threshold amount of movement). In some examples, the continued movement of electronic device 402 as shown in FIG. 4D is caused by continued movement of the head of user 404. In some examples, the continued movement of electronic device 402 causes the average amount of movement of electronic device 402 from the initial position of electronic device 402 shown in FIG. 4A to be larger over the period of time.

FIG. 4E illustrates user interface element 408 scrolled in a first direction in environment 406 (e.g., along the first axis (e.g., vertical axis)) based on the movement of electronic device 402 that exceeds the threshold amount of movement. As shown in FIG. 4E, scrolling user interface element 408 in the first direction corresponds to scrolling user interface element 408 upward. In some examples, the direction of scrolling of user interface element 408 in the mode of operation based on movement of electronic device 402 is based on a direction of rotation of electronic device 402 (e.g., caused by rotation of the head of user 404) relative to the first rotation axis (e.g., based on a direction of rotation of electronic device 402 about the pitch axis of electronic device 402). For example, as shown in FIG. 4E, user interface element 408 is scrolled upwards in response to rotation of electronic device 402 downwards (e.g., pitch rotation of electronic device 402 such that a forward direction of electronic device 402 is rotated toward a floor or ground in environment 406). In some examples, user interface element 408 is scrolled downwards in response to rotation of electronic device 402 downwards (e.g., pitch rotation of electronic device 402 such that a forward direction of electronic device 402 is rotated toward a sky or ceiling of environment 406). In some examples, electronic device 402 scrolls user interface element 408 in response to movement of electronic device 402 in a direction that is based on settings established by user 404 and stored in a memory of electronic device 402 (e.g., user 404 decides whether a direction of scrolling corresponds to the same direction of head rotation or a different direction of head rotation in a systems user interface presented by electronic device 402).

In some examples, scrolling user interface element 408 in the mode of operation that is based on movement (e.g., rotation) of electronic device 402 includes scrolling user interface element 408 by a magnitude and/or velocity (e.g., and optionally acceleration) that is based on the amount of movement of electronic device 402. For example, in accordance with an amount (e.g., an average amount over a period of time) of rotation of electronic device 402 being a first amount (e.g., corresponding to a first amount of change in orientation optionally from an initial orientation), electronic device 402 scrolls user interface element 408 by a first amount (e.g., by a first velocity and/or magnitude). In accordance with an amount of rotation of electronic device 402 being a second amount greater than the first amount, electronic device 402 scrolls user interface element 408 by a second amount that is greater than the first amount (e.g., by a second velocity and/or magnitude greater than the first velocity and/or magnitude). In some examples, scrolling user interface element 408 in the mode of operation that is based on movement of electronic device 402 includes scrolling user interface element 408 by a velocity (e.g., and/or acceleration) that is based on the velocity (e.g., and/or acceleration) of the movement of electronic device 402. For example, in accordance with a velocity of rotation (e.g., angular velocity) of electronic device 402 being a first value, electronic device 402 scrolls user interface element 408 by a first velocity (e.g., the first velocity corresponds to (e.g., is a velocity determined by electronic device 402 that is proportional to (e.g., greater than or less than) or equal to) the first value of the velocity of rotation of electronic device 402). In accordance with a velocity of rotation of electronic device 402 being a second value greater than the first value, electronic device 402 scrolls user interface element 408 by a second velocity greater than the first velocity (e.g., the second velocity corresponds to (e.g., is a velocity determined by electronic device 402 that is proportional to or equal to) the second value of the velocity of rotation of electronic device 402). In some examples, scrolling of user interface element 408 by the magnitude shown in FIG. 4E is based on the amount of rotation of electronic device 402 from a position (e.g., orientation) prior to initiating movement (e.g., as shown by the change in orientation of electronic device 402 from FIG. 4A to FIG. 4E). In some examples, user interface element 408 is scrolled with a velocity that is based on a velocity of movement of electronic device 402 (e.g., angular velocity of electronic device 402 relative to environment 406) from the position of electronic device 402 shown in FIG. 4A to the position of electronic device 402 shown in FIG. 4D.

As shown in FIG. 4E, the selectable option of the plurality of selectable options with the current focus is changed based on the scrolling of user interface element 408. Particularly, in FIG. 4E, selectable option 410z is presented as the selectable option of the plurality of selectable options with the current focus. In some examples, presenting selectable option 410z as the selectable option with the current focus includes presenting selectable option 410z with a greater amount of visual prominence (e.g., greater amount of opacity, brightness, color and/or size) compared to the selectable options currently visible in environment 406 that do not have the current focus. In some examples, scrolling user interface element 408 based on the movement (e.g., rotation) of electronic device 402 includes moving (e.g., in one or more dimensions as described above) and replacing the portion of the plurality of selectable options of user interface element 408 that are presented in environment 406. Particularly, selectable options 410e and 410f are replaced by selectable options 410v and 410w in environment 406 based on the scrolling of user interface element 408.

FIG. 4F illustrates an animation being presented in environment 406 in response to continued movement of electronic device 402 (e.g., while scrolling user interface element 408 in the mode of operation that is based on movement of electronic device 402) that is within a threshold amount of continued movement. In some examples, in response to the continued movement of electronic device 402 being within the threshold amount of continued movement, electronic device 402 ceases to scroll user interface element 408 in the mode of operation that is based on movement of electronic device 402. In some examples, the threshold amount of continued movement used by electronic device 402 for ceasing to scroll user interface element 408 in the mode of operation that is based on movement of electronic device 402 corresponds to an absolute amount of movement of electronic device 402 (e.g., a change in orientation of 0.1, 0.5, 1, 2, 3, 4, 5, 10, 15, 20 or 25 degrees) over a period of time (e.g., 0.1, 0.2, 0.5, 1, 2, 5 or 10 seconds). For example, upon initiating scrolling of user interface element 408 in the mode of operation that is based on movement (e.g., rotation) of electronic device 402, electronic device 402 tracks the absolute amount movement of electronic device 402 (e.g., independent of a direction of rotation of electronic device 402) to determine whether to maintain scrolling in the mode of operation that is based on movement of electronic device 402. Ceasing to scroll user interface element 408 in the mode of operation that is based on movement of electronic device 402 based on the absolute amount of movement of electronic device 402 as opposed to an average amount of movement of electronic device 402 ensures that a change in direction of head rotation made by user 404 does not cause electronic device 402 to cease scrolling user interface element 408 in the mode of operation that is based on movement of electronic device 402 when user 404 intends to maintain scrolling user interface element 408 in the mode of operation that is based on movement of electronic device 402.

In FIG. 4F, the head of user 404 maintains the same position (e.g., orientation) (e.g., relative to the first rotation axis (e.g., a pitch axis of electronic device 402)) for at least a threshold period of time. In some examples, in accordance with movement of electronic device 402 being within the threshold amount of movement (e.g., due to the head of user 404 maintaining the same position relative to environment 406 for more than a threshold period of time) electronic device 402 ceases to scroll user interface element 408 in the mode of operation that is based on movement of electronic device 402. As shown in FIG. 4F, the animation includes changing the spatial arrangement of the plurality of selectable options. Particularly, the animation includes increasing a distance between others of the plurality of selectable options in user interface element 408 and a location corresponding to a selectable option with the current focus (e.g., selectable option 410z as shown in FIG. 4F). In some examples, in accordance with the distance between the plurality of selectable options expanding, one or more selectable options cease to be presented in environment 406. As shown in FIG. 4F, selectable option 410v and selectable option 410d cease to be presented in environment 406. In some examples, ceasing to present selectable option 410v and selectable option 410d in environment 406 includes gradually reducing the visual prominence (e.g., opacity, brightness, color and/or size) of selectable option 410v and selectable option 410d. In some examples, presenting the animation includes maintaining a position of a selectable option of the plurality of selectable options that has the current focus in user interface element 408. As shown in FIG. 4F, selectable option 410z has the current focus in environment 406 and maintains its position (e.g., relative to the position of selectable option 410z in FIG. 4E) during the animation. In some examples, presenting the animation includes moving the selectable options visible in environment 406 in one or more dimensions. For example, selectable options 410v-410y are moved vertically upwards (e.g., and optionally farther from user 404 in the direction of depth) relative to the current viewpoint of user 404. For example, selectable options 410a-410d are moved vertically downwards (e.g., and optionally farther from user 404 in the direction of depth) relative to the current viewpoint of user 404.

FIG. 4G illustrates electronic device 402 ceasing to present the animation shown in FIG. 4F. Particularly, the selectable options that are currently visible in environment 406 are presented with the same spatial arrangement that was presented prior to initiating scrolling of user interface element 408 in the mode of operation that is based on movement of electronic device 402 (e.g., the spatial arrangement of the selectable options presented in environment 406 shown in FIG. 4A). In some examples, presenting the selectable options that are visible in environment 406 with the same spatial arrangement that was presented prior to initiating scrolling in the mode of operation based on movement of electronic device 402 includes ceasing to present one or more selectable options in environment 406. As shown in FIG. 4G, selectable option 410w and selectable option 410c cease to be presented in environment 406 (e.g., including one or more characteristics of ceasing to present selectable options 410v and selectable option 410d as described with reference to FIG. 4F). In some examples, after ceasing to present the animation, electronic device 402 maintains the selectable option of the plurality of selectable options that had the current focus prior to presenting the animation with the current focus in user interface element 408. Accordingly, in FIG. 4G, selectable option 410z is presented with the current focus in user interface element 408 (e.g., selectable option 410z maintains its position while electronic device 402 presents the animation as described with reference to FIG. 4F).

In some examples, after ceasing to scroll user interface element 408 in the mode of operation that is based on movement of electronic device 402, electronic device 402 establishes a threshold amount of movement for initiating scrolling of user interface element 408 in the mode of operation that is based on movement of electronic device 402 relative to an updated position (e.g., orientation) of electronic device 402. As shown in FIG. 4G, threshold lines 418a-418b are reconfigured to be set relative to the last position of electronic device 402 detected prior to ceasing to scroll user interface element 408 in the mode of operation that is based on movement of electronic device 402. In some examples, the threshold amount of movement for initiating scrolling of user interface element 408 has one or more characteristics of the threshold amount of movement described with reference to FIG. 4B. In some examples, in response to movement of the head of user 404 that corresponds to (e.g., causes) movement of electronic device 402 to exceed the threshold amount of movement for initiating scrolling of user interface element 408 in the mode of operation that is based on movement of electronic device 402, electronic device 402 initiates scrolling of user interface element 408 in the mode of operation that is based on the movement of electronic device 402. In some examples, in accordance with movement of the head of user 404 being within the threshold amount of movement for initiating scrolling of user interface element 408 in the mode of operation that is based on movement of electronic device 402, electronic device 402 permits scrolling of user interface element 408 in the mode of operation that is based on attention (e.g., gaze) of user 404 directed to user interface element 408 (e.g., as shown and described with reference to scrolling user interface element 308 in FIGS. 3A-3D).

FIG. 4H illustrates electronic device 402 establishing the threshold amount of movement for initiating scrolling of user interface element 408 relative to a neutral position of electronic device 402 (e.g., an orientation of electronic device 402 that is within 1, 2, 5, 10, 15, 20, 25, 30, 35, 40 or 45 degrees of being perpendicular to the first axis (e.g., the axis at which user interface element 408 is presented along) in environment 406). For example, after ceasing to scroll user interface element 408 in the mode of operation that is based on movement of electronic device 402, electronic device 402 permits user 404 to return their head to its original position (e.g., prior to initiating scrolling of user interface element 408 in the mode of operation that is based on movement of electronic device 402) prior to establishing the threshold amount of movement for initiating scrolling of user interface element 408 in the mode of operation that is based on movement of electronic device 402. Permitting user 404 to move their head to a neutral position relative to environment 406 prior to establishing a threshold amount of movement required to initiate scrolling of user interface element 408 in the mode of operation that is based on movement of electronic device 402 permits user 404 to rotate their head in a first direction or a second direction to initiate scrolling of user interface element 408 (e.g., and prevents a scenario where user 404 cannot initiate scrolling of user interface element 408 in a respective direction due to the threshold amount of movement being relative to a position of electronic device 402 that does not enable user 404 to rotate their head in a manner that exceeds the threshold amount of movement in the respective direction (e.g., due to the head of the user 404 being rotated to a respective maximum)).

FIG. 4I illustrates user 404 initiating head movement that causes movement of electronic device 402 that exceeds the threshold amount of movement for initiating scrolling of user interface element 408 in the mode of operation that is based on movement of electronic device 402. As shown in FIG. 4I, movement (e.g., rotation about the pitch axis) of electronic device 402 is in an opposite direction than previously shown in FIGS. 4A-4E. Accordingly, in response to the movement of electronic device 402, electronic device 402 initiates scrolling of user interface element 408 in the opposite direction compared to that previously shown in FIGS. 4A-4E. In some examples, initiating scrolling of user interface element 408 includes presenting the animation that includes changing the spatial arrangement of the selectable options visible in environment 406 as shown and described with reference to FIG. 4C. Particularly, electronic device 402 reduces the distance presented between the selectable options visible in environment 406 (e.g., by moving the selectable options in one or more dimensions relative to the current viewpoint of user 404), maintains selectable option 410z as the selectable option of the plurality of selectable options with the current focus, and presents selectable options 410w and 410c in environment 406 during the presentation of the animation.

FIG. 4J illustrates electronic device 402 ceasing to present the animation that includes changing the spatial arrangement of the selectable options visible in environment 406. Particularly, the selectable options of user interface element 408 that are visible in environment 406 are presented with a spatial arrangement that includes a reduced distance between the selectable options compared to that shown in FIG. 4I. During the animation, selectable option 410v and selectable option 410d are presented in environment 406. In some examples, while presenting the animation (e.g., after detecting movement of electronic device 402 that exceeds the threshold amount of movement for initiating scrolling of user interface element 408 in the mode of operation that is based on movement of electronic device 402), electronic device 402 tracks continued movement of electronic device 402 (e.g., corresponding to continued movement of the head of user 404). For example, electronic device 402 scrolls user interface element 408 based on the continued movement of electronic device 402 that exceeds the threshold amount of movement (e.g., the direction, magnitude, speed, velocity and/or acceleration of scrolling of user interface element 408 is based on the continued movement of electronic device 402).

FIG. 4K illustrates electronic device 402 scrolling user interface element 408 in a second direction based on the movement of electronic device 402 that exceeds the threshold amount of movement. In some examples, the user interface element 408 is scrolled in the second direction in accordance with the direction of movement (e.g., rotation) of electronic device 402 (e.g., caused by the direction of rotation of the head of user 404). As shown in FIG. 4K, scrolling user interface element 408 in the second direction corresponds to scrolling user interface element 408 downward. In some examples, the second direction is opposite from the first direction described with reference to FIG. 4E. In some examples, electronic device 402 scrolls user interface element 408 by a greater magnitude compared to that shown in FIG. 4E due to the magnitude of movement (e.g., the magnitude of the average amount of movement over a period of time) of electronic device 402 (e.g., relative to the position of electronic device 402 prior to initiating scrolling user interface element 408 in the mode of operation that is based on movement of electronic device 402) being greater compared to that shown in FIG. 4E. Accordingly, in FIG. 4K, electronic device 402 changes the selectable option of the plurality of selectable options that has the current focus from selectable option 410z to selectable option 410d in accordance with the movement of electronic device 402 that exceeds the threshold amount of movement (e.g., changing the selectable option of the plurality of selectable options that has the current focus includes one or more characteristics of changing the selectable option of the plurality of selectable options that has the current focus based on the scrolling of user interface element 408 as shown and described with reference to FIG. 4E). In some examples, the velocity and/or acceleration of scrolling of user interface element 408 in FIG. 4K is greater than the velocity and/or acceleration of scrolling of user interface element 408 shown in FIG. 4E due to the magnitude (e.g., and/or velocity and/or acceleration) of movement of electronic device 402 being greater in FIG. 4K than in FIG. 4E. As shown in FIG. 4K, changing the selectable option of the plurality of selectable options that has the current focus to selectable option 410d includes moving and/or replacing a portion of the plurality of selectable options associated with user interface element 408 that are visible in environment 406. Particularly, electronic device 402 ceases to present selectable options 410v-410y and presents selectable options 410e-410h in environment 406. In some examples, moving the selectable options associated with user interface element 408 that are visible in environment 406 includes moving the selectable options in one or more dimensions as described above.

In some examples, in accordance with electronic device 402 detecting continued movement (e.g., rotation) of electronic device 402 (e.g., caused by movement of the head of user 404) that exceeds a threshold amount of continued movement, electronic device 402 continues to scroll user interface element 408 based on the continued movement of electronic device 402. For example, electronic device 402 changes a direction, magnitude, velocity and/or acceleration of scrolling based on the continued movement of electronic device 402 (e.g., the direction of scrolling of user interface element 408 changes from the second direction to the first direction in response to a change in the direction of rotation of electronic device 402). In some examples, in accordance with a determination that the continued movement of electronic device 402 is within the threshold amount of continued movement, electronic device 402 ceases to scroll user interface element 408 in the mode of operation that is based on continued movement of electronic device 402.

FIGS. 5A-5B illustrate an electronic device presenting a user interface element in an environment that is scrollable along a second axis different than the first axis in an environment according to some examples of the disclosure. In some examples, the second axis extends in a horizontal (e.g., lateral) dimension relative to the current viewpoint of a user of the electronic device. In some examples, electronic device 502 has one or more characteristics of electronic device 302 and/or electronic device 402 shown and described with reference to FIGS. 3A-4K. As shown in FIGS. 5A-5B, electronic device 502 includes a display generation component 530 (e.g., display generation component 530 has one or more characteristics of display generation component 330 described with reference to FIGS. 3A-3D). In some examples, environment 506 has one or more characteristics of environment 306 and/or environment 406 shown and described with reference to FIGS. 3A-4K. In some examples, user interface element 508 includes one or more characteristics of user interface element 308 and/or 408 as described with reference to FIGS. 3A-4K. For example, user interface element 508 is a bounded or an unbounded list of content items (e.g., the content items are associated with a respective application or a system user interface of electronic device 502).

In FIG. 5A, user interface element 508 is presented in environment 506 and includes selectable options 510a-510c. In some examples, selectable options 510a-510c are a portion of a plurality of selectable options associated with user interface element 508 that are visible in environment 506 (e.g., the plurality of selectable options associated with user interface element 508 has one or more characteristics of the plurality of selectable options associated with user interface element 308 and/or user interface element 408 as described with reference to FIGS. 3A-4K). In some examples, user interface element 508 is scrollable in a mode of operation that is based on attention (e.g., gaze) of a user of electronic device 502 (e.g., user 504) that is directed to user interface element 508. For example, in accordance with gaze of user 504 being directed to selectable option 510c, electronic device 502 scrolls user interface element 508 to the left (e.g., relative to the current viewpoint of user 504) such that selectable option 510c becomes the center selectable option (e.g., the selectable option with the current focus), ceases to present selectable option 510a, and presents an additional selectable option in environment 506. In some examples, electronic device 502 presents visual feedback in response to attention being directed to user interface element 508. For example, an indication (e.g., having one or more characteristics of indication 312 and/or indication 412) is presented surrounding a respective selectable option of the plurality of selectable options associated with user interface element 508 that attention of user 504 is directed to. It should be appreciated that although FIG. 5A illustrates three selectable options presented in environment 506, user interface element 508 may include various sizes relative to environment 506 that provides space for more or less than three selectable options to be presented in environment 506.

In some examples, movement of electronic device 502 that exceeds a threshold amount of movement causes electronic device 502 to change the mode of operation of scrolling user interface element 508. Particularly, user interface element 508 is configured to be scrolled in a mode of operation that is based on movement of electronic device 502 that exceeds a threshold amount (e.g., a threshold amount of rotation about a second rotation axis, such as a yaw axis of electronic device 502, different from the first rotation axis described above). In FIG. 5A, an overhead view 520 is shown that includes user 504 of electronic device 502. In some examples, electronic device 502 is a head-mounted display that is worn by user 504. Additionally, threshold lines 518a-518b are shown relative to user 504. In some examples, threshold lines 518a-518b are a schematic representation of the threshold amount of movement (e.g., rotation about the yaw axis) of electronic device 502 that is required to scroll user interface element 508 in the mode of operation that is based on movement of electronic device 502. Additionally, a current orientation of electronic device 502 (e.g., represented by orientation arrow 516) is shown between threshold lines 518a-518b. In some examples, the threshold amount of movement is established relative to a current position (e.g., orientation) of electronic device 502 (e.g., relative to the second rotation axis). In some examples, movement of electronic device 502 relative to environment 506 corresponds to (e.g., is caused by) rotation of the head of user 504 relative to environment 506 (e.g., relative to the second rotation axis). In some examples, the threshold amount of movement of electronic device 502 corresponds to a threshold change in orientation (e.g., 0.1, 0.5, 1, 2, 3, 4, 5, 10, 15, 20, 25, 30, 35, 40, 45 or 50 degrees) from an initial position of electronic device 502 (e.g., as represented by orientation arrow 516 in FIG. 5A). In some examples, the threshold amount of movement of electronic device 502 has one or more characteristics of the threshold amount of movement of electronic device 402 described above.

In some examples, the threshold amount of movement corresponds to an average amount movement of electronic device 502 over a period of time (e.g., 0.1, 0.2, 0.5, 1, 2, 5 or 10 seconds). For example, the threshold amount of movement corresponds to an average amount of change in orientation of 0.1, 0.5, 1, 2, 3, 4, 5, 10, 15, 20, 25, 30, 35, 40, 45 or 50 degrees from an over 0.1, 0.2, 0.5, 1, 2, 5 or 10 seconds. In some examples, in accordance with a determination that a change in orientation of electronic device 502 exceeds the threshold amount of movement, electronic device 502 scrolls user interface element 508 (e.g., along the second axis in environment 506) in the mode of operation that is based on movement of electronic device 502. In some examples, in accordance with a determination that the movement of electronic device 502 does not exceed the threshold amount of movement, electronic device 502 maintains scrolling of user interface element 508 (e.g., along the second axis in environment 506) in the mode of operation that is based on detecting attention (e.g., gaze) of user 504 directed to user interface element 508.

In some embodiments, different selectable options of the plurality of selectable options associated with user interface element 508 are presented with different amounts of visual prominence based on their relative position in user interface element 508. For example, in some embodiments, selectable option 510a and selectable option 510c, which are shown as the leftmost selectable option and the right most selectable option visible in environment 506 in FIG. 5A, are presented with a visual prominence (e.g., opacity, brightness, color and/or size) that is less than the visual prominence of selectable option 510b, which is shown as the center-most selectable option visible in environment 506 in FIG. 5A. In some embodiments, while scrolling user interface element 508 (e.g., in the mode of operation that is based on attention of user 504 directed to user interface element 508 or in the mode of operation that is based on movement of electronic device 502), electronic device 502 changes the visual prominence (e.g., opacity, brightness, color and/or size) of the selectable options that are visible in environment 506. For example, as a respective selectable option that is visible in environment 506 is moved from the center of user interface element 508 toward the left or right side of user interface element 508 (e.g., from the current viewpoint of user 504) during the scrolling of user interface element 508, electronic device 502 reduces the visual prominence of the respective selectable option. For example, as a respective selectable option that is visible in environment 506 is moved from the left or right side of user interface element 508 toward the center of user interface element 508 (e.g., from the current viewpoint of user 504) during the scrolling of user interface element 508, electronic device 502 increases the visual prominence of the respective selectable option.

FIG. 5B illustrates electronic device 502 scrolling user interface element 508 in the mode of operation that is based on movement of electronic device 502 in response to detecting movement of electronic device 502 that exceeds the threshold amount of movement. In some examples, the movement of electronic device 502 that exceeds the threshold amount of movement corresponds to (e.g., is caused by) movement (e.g., rotation) of the head of user 504. As shown in overhead view 520 in FIG. 5B, orientation arrow 516 (e.g., representing an orientation of electronic device 502 relative to environment 506) exceeds threshold line 518b (e.g., representing the threshold amount of movement from the position of electronic device 502 in FIG. 5A). Accordingly, electronic device 502 initiates scrolling of user interface element 508 in the mode of operation that is based on movement of electronic device 502. In some examples, electronic device 502 scrolls user interface element 508 with a magnitude, velocity and/or acceleration that is based on the magnitude, velocity, and/or acceleration of the movement of electronic device 502 that exceeds the threshold amount of movement (e.g., relative to the second rotation axis).

In some examples, initiating scrolling of user interface element 508 includes presenting an animation that includes changing the spatial arrangement of the selectable options associated with user interface element 508 that are visible in environment 506. Particularly, as shown in FIG. 5B, a distance between the selectable options associated with user interface element 508 is reduced (e.g., compared to that shown in FIG. 5A). Due to the distance between the selectable options associated with user interface element 508 being reduced in environment 506, one or more additional selectable options (e.g., selectable options 510d-510g) are able to be presented by electronic device 502. In some examples, presenting the animation includes moving the selectable options associated with user interface element 508 that are visible in environment 506. In some examples, the movement of the selectable options includes movement in one or more dimensions in environment 506 (e.g., in a horizontal dimension, or in the horizontal dimension and in a dimension of depth in environment 506 from the current viewpoint of user 504). For example, user interface element 508 is a carousel list (e.g., the list includes a continuous cycle of the plurality of selectable options associated with user interface element 508), and selectable options are presented at a greater distance (e.g., relative to the dimension of depth from the current viewpoint of user 504) when moved from the center of user interface element 508 toward the left or right sides of user interface element 508 in environment 506. In some examples, presenting the animation includes changing the visual prominence (e.g., opacity, brightness, color and/or size) of the selectable options associated with user interface element 508 (e.g., an opacity of a respective selectable option is reduced when the respective selectable option is moved from the center of user interface element 508 toward the left or right sides of user interface element 508).

In FIG. 5B, as a result of the scrolling of user interface element 508 based on the movement of electronic device 502, the selectable option of the plurality of selectable options associated with user interface element 508 that has the current focus is changed. Particularly, electronic device 502 scrolls user interface element 508 to the left and changes the selectable option presented at approximately the center of user interface element 508 (e.g., corresponding to a selectable option that has a current focus) from selectable option 510b (e.g., as shown in FIG. 5A) to selectable option 510d. In some examples, user interface element 508 is scrolled to the left (e.g., from the current viewpoint of user 504) based on the direction of rotation of electronic device 502 toward the right (e.g., from the perspective of user 504 and as shown in overhead view 520). In some examples, user interface element 508 is scrolled to the right based on the direction of rotation of electronic device 502 toward the right (e.g., electronic device 502 scrolls user interface element 508 in a direction that is based on information stored in a memory of electronic device 502 (e.g., the information corresponds to settings that are determined by user 504)). In some examples, scrolling user interface element 508 includes movement of the selectable options of the plurality of selectable options associated with user interface element 508 that are visible in environment 506. Particularly, selectable options 510a-510c are moved to the left relative to the current viewpoint of user 504. Selectable options 510d-510g are presented in environment 506 (e.g., due to the change in spatial arrangement of the selectable options that are presented in environment 506 providing space for additional selectable options to be presented in environment 506). In some examples, the movement of the selectable options in accordance with the scrolling of user interface element 508 includes movement in one or more dimensions (e.g., in a horizontal dimension, or in the horizontal dimension and in a dimension of depth in environment 506 from the current viewpoint of user 504). In some examples, the movement of the selectable options in accordance with the scrolling of user interface element 508 includes changing the visual prominence of one or more selectable options (e.g., opacity, brightness, color and/or size). For example, the selectable options visible in environment 506 that are moved to a location in close proximity to the left or right sides of user interface element 508 (e.g., selectable option 510a and selectable option 510g) are presented with less visual prominence compared to the selectable options moved to a location closer to the center of user interface element 508 (e.g., selectable options 510c-510e). It should be appreciated that although FIG. 5B illustrates seven selectable options presented in environment 506, user interface element 508 may include various sizes relative to environment 506 while scrolling in the mode of operation based on movement of electronic device 502 that provides space for more or less than seven selectable options to be presented in environment 506.

In some examples, electronic device 502 tracks continued movement of electronic device 502 (e.g., that corresponds to movement of the head of user 504) while scrolling user interface element 508 in the mode of operation that is based on movement of electronic device 502. In some examples, electronic device 502 continues to scroll user interface element 508 based on continued movement of electronic device 502 that is detected while scrolling user interface element 508 in the mode of operation that is based on movement of electronic device 502. In some examples, in accordance with a determination that movement of electronic device 502 is within a threshold amount (e.g., corresponding to an absolute amount of movement over a period of time), electronic device 502 ceases to scroll user interface element 508 in the mode of operation that is based on movement of electronic device 502. In some examples, ceasing to scroll user interface element 508 in the mode of operation that is based on movement of electronic device 502 includes presenting an animation that includes changing a spatial arrangement of the selectable options of the plurality of selectable options that are visible in environment 506. For example, changing the spatial arrangement of the selectable options includes increasing a distance presented between the selectable options (e.g., causing one or more selectable options to cease to be presented in environment 506) while concurrently maintaining a location of the selectable option that had the current focus when the continued movement of electronic device 502 within the threshold amount was detected. In some examples, upon ceasing to scroll user interface element 508 in the mode of operation that is based on movement of electronic device 502, electronic device 502 permits user 504 to scroll user interface element 508 in the mode of operation that is based on attention (e.g., gaze) of user 504 directed to user interface element 508.

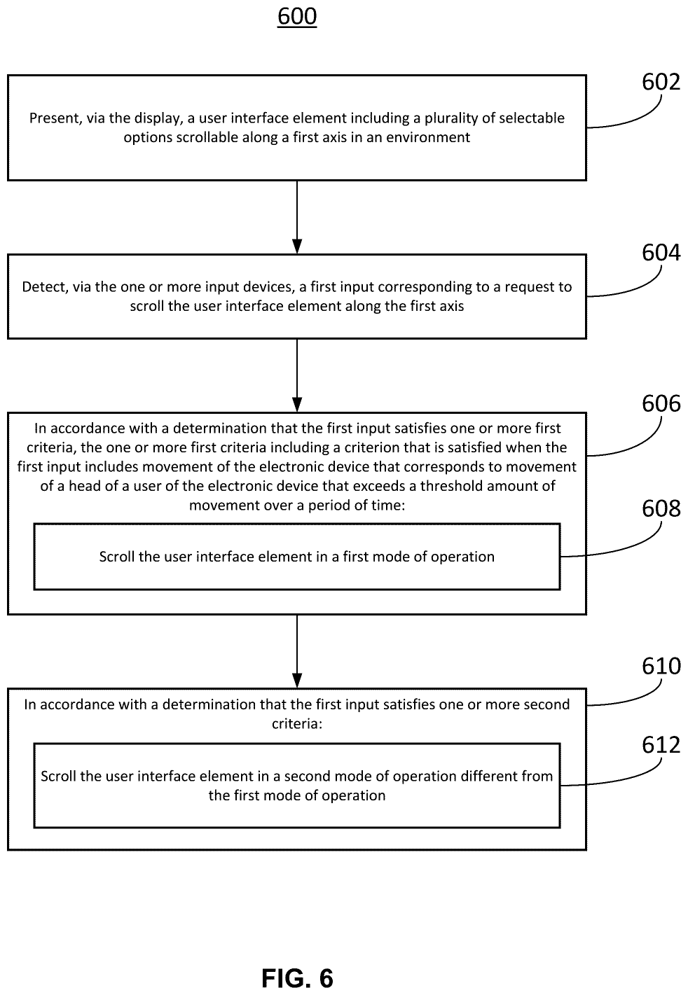

FIG. 6 illustrates a flow diagram illustrating an example process for scrolling a user interface element in a first mode of operation or a second mode of operation based on detection of movement of an electronic device according to some examples of the disclosure. In some examples, process 600 begins at an electronic device in communication with a display and one or more input devices. In some examples, the electronic device is optionally a head-mounted display similar or corresponding to device 201 in FIG. 2. As shown in FIG. 6, in some examples, at 602, the electronic devices presents, via the display, a user interface element including a plurality of selectable options scrollable along a first axis in an environment, such as user interface element 308 presented by electronic device 302 in environment 306 as shown in FIGS. 3A-3D, user interface element 408 presented by electronic device 402 in environment 406 as shown in FIGS. 4A-4K, or user interface element 508 presented by electronic device 502 in environment 506 as shown in FIGS. 5A-5B.

In some examples, at 604, the electronic device detects, via the one or more input devices, a first input corresponding to a request to scroll the user interface element along the first axis. For example, the input includes attention of the user of the electronic device directed to the user interface element, such as gaze 314 directed to selectable option 310d of user interface element 308 shown in FIG. 3C. For example, the input includes movement (e.g., rotation, optionally about a pitch axis) of the electronic device, such as the rotation of electronic device 402 (e.g., represented by orientation arrow 416) shown in FIG. 4C.

In some examples, at 606, in accordance with a determination that the first input satisfies one or more first criteria, the one or more criteria including a criterion that is satisfied when the first input includes movement of the electronic device that corresponds to movement of a head of a user of the electronic device that exceeds a threshold amount of movement relative to over a period of time (e.g., 0.1, 0.2, 0.5, 1, 2, 5, or 10 seconds), the electronic device, at 608, scrolls the user interface element in a first mode of operation. For example, as shown in FIGS. 4C-4E, electronic device 402 scrolls user interface element 408 in a mode of operation that is based on movement of electronic device 402 in response to an input corresponding to movement of electronic device 402 that exceeds a threshold amount of movement.

In some examples, at 610, in accordance with a determination that the first input satisfies one or more second criteria, the electronic device, at 612, scrolls the user interface element in a second mode of operation different from the first mode of operation. For example, as shown in FIGS. 3C-3D, electronic device 302 scrolls user interface element 308 in a mode of operation that is based on attention of user 304 that is directed to user interface element 308 in response to an input corresponding to attention (e.g., gaze 314) of user 304 being directed to selectable option 310d.

It is understood that process 600 is an example and that more, fewer, or different operations can be performed in the same or in a different order. Additionally, the operations in process 600 described above are, optionally, implemented by running one or more functional modules in an information processing apparatus such as general-purpose processors (e.g., as described with respect to FIG. 2) or application specific chips, and/or by other components of FIG. 2.

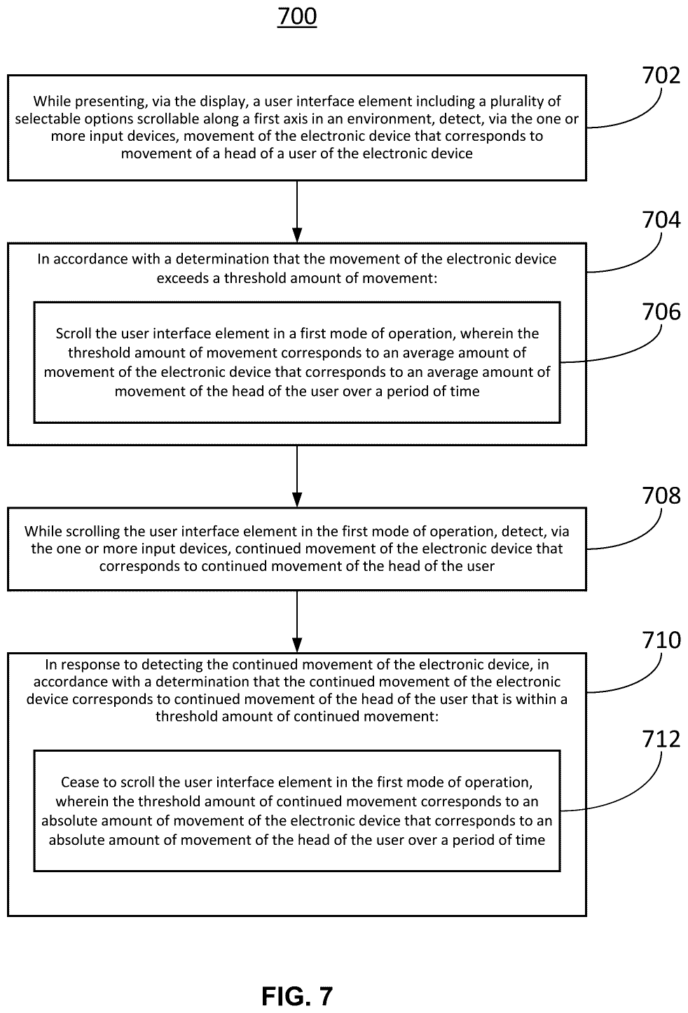

FIG. 7 illustrates a flow diagram illustrating an example process for scrolling a user interface element in a first mode of operation and ceasing to scroll the user interface element in the first mode of operation according to some examples of the disclosure. In some examples, process 700 begins at an electronic device in communication with a display and one or more input devices. In some examples, the electronic device is optionally a head-mounted display similar or corresponding to device 201 in FIG. 2. As shown in FIG. 7, in some examples, at 702, while presenting, via the display, a user interface element including a plurality of selectable options scrollable along a first axis in an environment (e.g., user interface element 408 shown in FIGS. 4A-4K or user interface element 508 shown in FIGS. 5A-5B), the electronic device detects, via the one or more input devices, movement of the electronic device that corresponds to movement of a head of a user of the electronic device, such as the movement of electronic device 402 shown in FIGS. 4A-4E. In some examples, operation 702 of process 700 corresponds to operations 602 and 604 of process 600 shown and described with reference to FIG. 6.

In some examples, at 704, in accordance with a determination that the movement of the electronic device exceeds a threshold amount of movement (e.g., corresponding to a threshold distance, magnitude, speed, velocity, and/or acceleration optionally for at least a threshold period of time), the electronic device, at 706, scrolls the user interface element in a first mode of operation, wherein the threshold amount of movement corresponds to an average amount of movement of the electronic device that corresponds to an average amount of movement of the head of the user over a period of time. For example, as shown in FIGS. 4A-4E, electronic device 402 scrolls user interface element 408 in response to the movement of electronic device 402 (e.g., that corresponds to movement of the head of user 404) that exceeds the threshold amount of movement. In some examples, the movement of electronic device 402 that exceeds the threshold amount of movement in FIG. 4C corresponds to an average amount of movement of electronic device 402 (e.g., from the initial position of electronic device 402 shown in FIG. 4A). For example, the average amount of movement of electronic device 402 is determined over a period of time (e.g., 0.1, 0.2, 0.5, 1, 2, 5 or 10 seconds). In some examples, the average amount of movement of electronic device 402 corresponds to an average change in orientation of 0.1, 0.5, 1, 2, 3, 4, 5, 10, 15, 20, 25, 30, 35, 40, 45 or 50 degrees (e.g., from an initial orientation of electronic device 402) over the period of time. In some examples, the threshold amount of movement is exceeded when the electronic device maintains an average amount of movement that is above a threshold amount for at least a threshold period of time (e.g., the average movement of electronic device per frame exceeds a threshold amount of movement per frame over a set of 5 sequential frames). In some examples, operations 704 and 706 of process 700 correspond to operations 606 and 608 of process 600 shown and described with reference to FIG. 6.

In some examples, at 708, while scrolling the user interface element in the first mode of operation, the electronic device detects, via the one or more input devices, continued movement of the electronic device that corresponds to continued movement of the head of the user. For example, in FIG. 4E, electronic device 402 detects continued movement of electronic device 402 that corresponds to continued movement of the head of user 404 while scrolling user interface element 408 in the mode of operation that is based on movement of electronic device 402.

In some examples, at 710, in response to detecting the continued movement of the electronic device, in accordance with a determination that the continued movement of the electronic device corresponds to continued movement of the head of the user that is within a threshold amount of continued movement, the electronic device, at 712, ceases to scroll the user interface element in the first mode of operation, wherein the threshold amount of continued movement corresponds to an absolute amount of movement of the electronic device that corresponds to an absolute amount of movement of the head of the user over a period of time. For example, as shown in FIGS. 4F-4G, electronic device 402 ceases to scroll user interface element 408 in response to the movement of electronic device 402 (e.g., corresponding to movement of the head of user 404) that is within the threshold amount of continued movement of electronic device 402. In some examples, the continued movement of electronic device 402 that is within the threshold amount of continued movement of electronic device 402 in FIG. 4F corresponds to an absolute amount of continued movement of electronic device 402. For example, detecting movement of electronic device 402 relative to the threshold amount of continued movement of electronic device 402 is independent of detecting a direction of movement (e.g., rotation) of electronic device 402. In some examples, the threshold amount of continued movement corresponds to an absolute amount of change in orientation of the electronic device of 0.1, 0.5, 1, 2, 3, 4, 5, 10, 15, 20 or 25 degrees in the environment over a period of time of 0.1, 0.5, 1, 2, 5 or 10 seconds. In some examples, operations 708-712 occur while scrolling the user interface element in the first mode of operation at operation 608 of process 600 shown and described with reference to FIG. 6.

It is understood that process 700 is an example and that more, fewer, or different operations can be performed in the same or in a different order. Additionally, the operations in process 700 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising, at an electronic device in communication with one or more displays and one or more input devices, presenting, via the one or more displays, a user interface element including a plurality of selectable options scrollable along a first axis in an environment, and detecting, via the one or more input devices, a first input corresponding to a request to scroll the user interface element along the first axis. In some examples, the method further comprises, in accordance with a determination that the first input satisfies one or more first criteria, the one or more first criteria including a criterion that is satisfied when the first input includes movement of the electronic device that corresponds to movement of a head of a user of the electronic device that exceeds a threshold amount of movement over a period of time, scrolling the user interface element in a first mode of operation. In some examples, the method further comprises, in accordance with a determination that the first input satisfies one or more second criteria, scrolling the user interface element in a second mode of operation different from the first mode of operation.

Additionally, or alternatively, in some examples, the movement of the electronic device corresponds to rotation of the electronic device that corresponds to rotation of the head of the user, and scrolling the user interface element in the first mode of operation includes scrolling the user interface element based on the rotation of the electronic device.

Additionally, or alternatively, in some examples, a velocity of the scrolling of the user interface element in the first mode of operation is based on a detected amount of the rotation of the electronic device that corresponds to the rotation of the head of the user.

Additionally, or alternatively, in some examples, a direction of the scrolling of the user interface element in the first mode of operation is based on a detected direction of the rotation of the electronic device that corresponds to the rotation of the head of the user.

Additionally, or alternatively, in some examples, scrolling the user interface element is independent of a location of gaze of the user relative to the user interface element.

Additionally, or alternatively, in some examples, scrolling the user interface element in the second mode of operation includes scrolling the user interface element based on detecting gaze of the user directed to the user interface element.

Additionally, or alternatively, in some examples, the one or more second criteria include a criterion that is satisfied when the first input includes a change in a location of gaze of the user from being directed to a first selectable option of the plurality of selectable options to a second selectable option, different from the first selectable option, of the plurality of selectable options.

Additionally, or alternatively, in some examples, the one or more second criteria include a criterion that is satisfied when the first input includes movement of the electronic device that corresponds to movement of the head of the user of the electronic device that is within the threshold amount of movement.

Additionally, or alternatively, in some examples, the threshold amount of movement corresponds to an average amount of movement of the electronic device that corresponds to an average amount of movement of the head of the user over the period of time.

Additionally, or alternatively, in some examples, the movement of the head of the user of the electronic device is about a pitch axis and the threshold amount of movement corresponds to an amount of rotation about the pitch axis.

Additionally, or alternatively, in some examples, the method further comprises, while scrolling the user interface element in the first mode of operation, detecting, via the one or more input devices, continued movement of the electronic device that corresponds to movement of the head of the user, and in response to detecting the continued movement of the electronic device, in accordance with a determination that the continued movement of the electronic device that corresponds to continued movement of the head of the user is within a threshold amount of continued movement over a second period of time, ceasing to scroll the user interface element in the first mode of operation, wherein the threshold amount of continued movement corresponds to an absolute amount of movement of the electronic device that corresponds to an absolute amount of movement of the head of the user relative to the first axis over the second period of time.

Additionally, or alternatively, in some examples, the method further comprises, in accordance with the determination that the first input satisfies the one or more first criteria, presenting, via the one or more displays, visual feedback in the environment while initiating scrolling of the user interface element in the first mode of operation.

Additionally, or alternatively, in some examples, the method further comprises, while presenting the user interface element including the plurality of selectable options in the environment, presenting the plurality of selectable options with a first spatial arrangement relative to the environment, wherein presenting the visual feedback in the environment includes presenting the plurality of selectable options with a second spatial arrangement, different from the first spatial arrangement, relative to the environment.

Additionally, or alternatively, in some examples presenting the plurality of selectable options with the second spatial arrangement includes presenting an animation in the environment, wherein presenting the animation includes gradually decreasing a distance between the plurality of selectable options and a location of a first selectable option of the plurality of selectable options.

Additionally, or alternatively, in some examples, the method further comprises, while scrolling the user interface element in the first mode of operation, detecting, via the one or more input devices, continued movement of the electronic device that corresponds to movement of the head of the user. In some examples, in response to detecting the continued movement of the electronic device, in accordance with a determination that the continued movement of the electronic device does not exceed a threshold amount of continued movement over a second period of time, ceasing to scroll the user interface element in the first mode of operation, and while ceasing to scroll the user interface element in the first mode of operation, presenting, via the one or more displays, visual feedback in the environment.

Additionally, or alternatively, in some examples, the method further comprises, while scrolling the user interface element in the first mode of operation, presenting the plurality of selectable options with a first spatial arrangement relative to the environment, wherein presenting the visual feedback in the environment includes presenting the plurality of selectable options with a second spatial arrangement, different from the first spatial arrangement, relative to the environment.

Additionally, or alternatively, in some examples, presenting the plurality of selectable options with the second spatial arrangement includes presenting an animation in the environment, wherein presenting the animation includes gradually increasing a distance between the plurality of selectable options from a location of a first selectable option of the plurality of selectable options.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the invention to the precise forms disclosed. Many modifications and variations are possible in view of the above teachings. The examples were chosen and described in order to best explain the principles of the invention and its practical applications, to thereby enable others skilled in the art to best use the invention and various described examples with various modifications as are suited to the particular use contemplated.

What is claimed is:

1. A method, comprising:
at an electronic device in communication with one or more displays and one or more input devices:
presenting, via the one or more displays, a user interface element including a plurality of selectable options scrollable along a first axis in an environment;
detecting, via the one or more input devices, a first input corresponding to a request to scroll the user interface element along the first axis;
in accordance with a determination that the first input satisfies one or more first criteria, the one or more first criteria including a criterion that is satisfied when the first input includes movement of the electronic device that corresponds to movement of a head of a user of the electronic device that exceeds a threshold amount of movement over a period of time, scrolling the user interface element in a first mode of operation; and
in accordance with a determination that the first input satisfies one or more second criteria, scrolling the user interface element in a second mode of operation different from the first mode of operation.

2. The method of claim 1, wherein the movement of the electronic device corresponds to rotation of the electronic device that corresponds to rotation of the head of the user, and scrolling the user interface element in the first mode of operation includes scrolling the user interface element based on the rotation of the electronic device.

3. The method of claim 1, wherein scrolling the user interface element in the second mode of operation includes scrolling the user interface element based on detecting gaze of the user directed to the user interface element.

4. The method of claim 1, wherein the one or more second criteria include a criterion that is satisfied when the first input includes a change in a location of gaze of the user from being directed to a first selectable option of the plurality of selectable options to a second selectable option, different from the first selectable option, of the plurality of selectable options.

5. The method of claim 1, wherein the one or more second criteria include a criterion that is satisfied when the first input includes movement of the electronic device that corresponds to movement of the head of the user of the electronic device that is within the threshold amount of movement over the period of time.

6. The method of claim 1, wherein the threshold amount of movement corresponds to an average amount of movement of the electronic device that corresponds to an average amount of movement of the head of the user over the period of time.

7. The method of claim 1, wherein the movement of the head of the user of the electronic device is about a pitch axis and the threshold amount of movement corresponds to an amount of rotation about the pitch axis.

8. The method of claim 1, further comprising:
while scrolling the user interface element in the first mode of operation, detecting, via the one or more input devices, continued movement of the electronic device that corresponds to movement of the head of the user; and
in response to detecting the continued movement of the electronic device, in accordance with a determination that the continued movement of the electronic device that corresponds to continued movement of the head of the user is within a threshold amount of continued movement over a second period of time, ceasing to scroll the user interface element in the first mode of operation, wherein the threshold amount of continued movement corresponds to an absolute amount of movement of the electronic device that corresponds to an absolute amount of movement of the head of the user over the second period of time.

9. An electronic device comprising:
one or more processors;
memory; and
one or more programs stored in the memory and configured to be executed by the one or more processors, the one or more programs including instructions for performing a method comprising:
presenting, via one or more displays, a user interface element including a plurality of selectable options scrollable along a first axis in an environment;
detecting, via one or more input devices, a first input corresponding to a request to scroll the user interface element along the first axis;
in accordance with a determination that the first input satisfies one or more first criteria, the one or more first criteria including a criterion that is satisfied when the first input includes movement of the electronic device that corresponds to movement of a head of a user of the electronic device that exceeds a threshold amount of movement over a period of time, scrolling the user interface element in a first mode of operation; and
in accordance with a determination that the first input satisfies one or more second criteria, scrolling the user interface element in a second mode of operation different from the first mode of operation.

10. The electronic device of claim 9, wherein the movement of the electronic device corresponds to rotation of the electronic device that corresponds to rotation of the head of the user, and scrolling the user interface element in the first mode of operation includes scrolling the user interface element based on the rotation of the electronic device.

11. The electronic device of claim 9, wherein scrolling the user interface element in the second mode of operation includes scrolling the user interface element based on detecting gaze of the user directed to the user interface element.

12. The electronic device of claim 9, wherein the one or more second criteria include a criterion that is satisfied when the first input includes a change in a location of gaze of the user from being directed to a first selectable option of the plurality of selectable options to a second selectable option, different from the first selectable option, of the plurality of selectable options.

13. The electronic device of claim 9, wherein the one or more second criteria include a criterion that is satisfied when the first input includes movement of the electronic device that corresponds to movement of the head of the user of the electronic device that is within the threshold amount of movement over the period of time.

14. The electronic device of claim 9, wherein the threshold amount of movement corresponds to an average amount of movement of the electronic device that corresponds to an average amount of movement of the head of the user over the period of time.

15. The electronic device of claim 9, wherein the movement of the head of the user of the electronic device is about a pitch axis and the threshold amount of movement corresponds to an amount of rotation about the pitch axis.

16. The electronic device of claim 9, wherein the method further comprises:
while scrolling the user interface element in the first mode of operation, detecting, via the one or more input devices, continued movement of the electronic device that corresponds to movement of the head of the user; and
in response to detecting the continued movement of the electronic device, in accordance with a determination that the continued movement of the electronic device that corresponds to continued movement of the head of the user is within a threshold amount of continued movement over a second period of time, ceasing to scroll the user interface element in the first mode of operation, wherein the threshold amount of continued movement corresponds to an absolute amount of movement of the electronic device that corresponds to an absolute amount of movement of the head of the user over the second period of time.

17. A non-transitory computer readable storage medium storing one or more programs, the one or more programs comprising instructions, which when executed by one or more processors of an electronic device, cause the electronic device to perform a method comprising:
presenting, via one or more displays, a user interface element including a plurality of selectable options scrollable along a first axis in an environment;
detecting, via one or more input devices, a first input corresponding to a request to scroll the user interface element along the first axis;
in accordance with a determination that the first input satisfies one or more first criteria, the one or more first criteria including a criterion that is satisfied when the first input includes movement of the electronic device that corresponds to movement of a head of a user of the electronic device that exceeds a threshold amount of movement over a period of time, scrolling the user interface element in a first mode of operation; and
in accordance with a determination that the first input satisfies one or more second criteria, scrolling the user interface element in a second mode of operation different from the first mode of operation.

18. The non-transitory computer readable storage medium of claim 17, wherein the movement of the electronic device corresponds to rotation of the electronic device that corresponds to rotation of the head of the user, and scrolling the user interface element in the first mode of operation includes scrolling the user interface element based on the rotation of the electronic device.

19. The non-transitory computer readable storage medium of claim 17, wherein scrolling the user interface element in the second mode of operation includes scrolling the user interface element based on detecting gaze of the user directed to the user interface element.

20. The non-transitory computer readable storage medium of claim 17, wherein the one or more second criteria include a criterion that is satisfied when the first input includes a change in a location of gaze of the user from being directed to a first selectable option of the plurality of selectable options to a second selectable option, different from the first selectable option, of the plurality of selectable options.

21. The non-transitory computer readable storage medium of claim 17, wherein the one or more second criteria include a criterion that is satisfied when the first input includes movement of the electronic device that corresponds to movement of the head of the user of the electronic device that is within the threshold amount of movement over the period of time.

22. The non-transitory computer readable storage medium of claim 17, wherein the threshold amount of movement corresponds to an average amount of movement of the electronic device that corresponds to an average amount of movement of the head of the user over the period of time.

23. The non-transitory computer readable storage medium of claim 17, wherein the movement of the head of the user of the electronic device is about a pitch axis and the threshold amount of movement corresponds to an amount of rotation about the pitch axis.

24. The non-transitory computer readable storage medium of claim 17, wherein the method further comprises:
while scrolling the user interface element in the first mode of operation, detecting, via the one or more input devices, continued movement of the electronic device that corresponds to movement of the head of the user; and
in response to detecting the continued movement of the electronic device, in accordance with a determination that the continued movement of the electronic device that corresponds to continued movement of the head of the user is within a threshold amount of continued movement over a second period of time, ceasing to scroll the user interface element in the first mode of operation, wherein the threshold amount of continued movement corresponds to an absolute amount of movement of the electronic device that corresponds to an absolute amount of movement of the head of the user over the second period of time.
